(19) United States
(12) Patent Application Publication
(10) Pub. No.: US 2025/0144587 A1
(43) Pub. Date: May 8, 2025

(54) REACTION ASSEMBLIES, REACTOR SYSTEMS INCLUDING THE SAME, AND ASSOCIATED METHODS

(71) Applicant: Oregon State University, Corvallis, OR (US)

(72) Inventors: Juvenal A. Ortiz Ulloa, Corvallis, OR (US); Nicholas J. AuYeung, Corvallis, OR (US)

(73) Assignee: Oregon State University, Corvallis, OR (US)

(21) Appl. No.: 18/935,353

(22) Filed: Nov. 1, 2024

Related U.S. Application Data
(60) Provisional application No. 63/596,149, filed on Nov. 3, 2023.

(51) Int. Cl. B01J 8/18

(52) U.S. Cl. CPC B01J 8/1827; B01J 8/1836; B01J 2208/00115; B01J 2208/00761; B01J 2208/00902

(57) ABSTRACT

Reaction assemblies, reactor systems including the same, and associated methods are disclosed. In an example, a reaction assembly includes a reaction assembly housing, a moving bed region, a gas acceleration region, and a reactive bed region. The gas acceleration region includes a nozzle configured to accelerate a reaction gas and one or more downcomer regions defined between the nozzle and the reaction assembly housing. A flow of reaction gas is accelerated within the gas acceleration region to produce a fluidizing gas flow to facilitate a chemical reaction between the reaction gas and reaction particles within the reactive bed region. A reactor system can include a reactor enclosure, a reaction particle inlet, a reaction gas inlet, and a reaction assembly. A method can include introducing a flow of reaction particles and a flow of reaction gas into a reactor enclosure and flowing the reaction gas in contact with the reaction particles.

### CROSS-REFERENCE TO RELATED APPLICATION

This application claims the benefit of U.S. Provisional Patent Application No. 63/596,149, filed on Nov. 3, 2023, which is incorporated by reference herein in its entirety.

### ACKNOWLEDGEMENT OF GOVERNMENT SUPPORT

This invention was made with government support under Award No. DE-EE0008992 awarded by the U.S. Department of Energy. The government has certain right in the invention.

### FIELD

The present disclosure relates generally to reaction assemblies, and more specifically to reaction assemblies that support counterpropagating flows of a reaction gas and reaction particles to produce regions with different dynamical properties within the reaction assemblies.

### BACKGROUND

Thermochemical energy storage (TCES) using metal oxide particles has emerged as a promising technology to enable renewable energy dispatchability. The basic principle of TCES is to store energy as chemical bonds in metal oxide particles for short or long-term periods, which can then be released as heat when needed. In addition to providing energy storage, TCES offers several other advantages, including high energy density, decoupled charging and discharging steps for long-term storage, and delivery of high temperature heat (˜1000° C.). However, there are inherent mass and heat transfer limitations associated with the oxidation reaction that takes place during the discharge process due to the interaction of solids and gases. While the design space for oxidation reactors offers numerous possibilities, including solid-gas contacting patterns like moving beds, fixed beds, and fluidized beds, there is currently no effective decoupled discharge reactor design that can accommodate a heat transfer fluid different than the process gas or fluidizing gas.

### SUMMARY

Reaction assemblies, reactor systems including the same, and associated methods are disclosed herein.

In a representative example, a reaction assembly for facilitating a chemical reaction between a reaction gas and reaction particles within a reactor system includes a reaction assembly housing, a moving bed region, a gas acceleration region, and a reactive bed region. The reaction assembly housing is configured to support a flow of the reaction gas in an upstream direction and a flow of the reaction particles in a downstream direction opposite to the upstream direction. The gas acceleration region is positioned upstream of the moving bed region, and the reactive bed region is positioned upstream of the gas acceleration region. The gas acceleration region includes a nozzle configured to accelerate the reaction gas and one or more downcomer regions defined between the nozzle and the reaction assembly housing. The reaction assembly is configured such that, during operative use of the reaction assembly, the reaction gas flows in contact with the reaction particles in the moving bed region. Additionally, during operative use of the reaction assembly, a portion of the flow of the reaction gas is accelerated within the gas acceleration region to produce a fluidizing gas flow and the fluidizing gas flow causes fluidizing of the reaction particles within the reactive bed region to facilitate the chemical reaction between the reaction gas and the reaction particles within the reactive bed region.

In another representative example, a reactor system includes a reactor enclosure, a reaction particle inlet configured to introduce reaction particles into the reactor enclosure, and a reaction gas inlet configured to introduce a flow of a reaction gas into the reactor enclosure. The reactor system is configured such that the reaction particles flow through the reactor enclosure in a downstream direction, and the reactor system is configured such that the reaction gas flows through the reactor enclosure in an upstream direction opposite to the downstream direction. The reactor system additionally includes a reaction assembly disposed between the reaction particle inlet and the reaction gas inlet.

In another representative example, a method of operating a reactor system includes introducing a flow of reaction particles into a reactor enclosure of the reactor system such that the reaction particles flow through the reactor enclosure in a downstream direction and introducing a flow of a reaction gas into the reactor enclosure such the reaction gas flows through the reactor enclosure in an upstream direction opposite to the downstream direction. The method additionally includes flowing the reaction gas in contact with the reaction particles within a reaction assembly of the reactor system such that the reaction gas interacts with the reaction particles to produce a moving bed region, a gas acceleration region, and a reactive bed region of the reaction assembly. In the moving bed region, the reaction gas flows in contact with the reaction particles and flows with a superficial velocity that is lower than a fluidizing gas velocity corresponding to the reaction particles. In the gas acceleration region, a first portion of the flow of reaction gas is accelerated to produce a fluidizing gas flow with a superficial velocity that is greater than a fluidizing gas velocity corresponding to the reaction particles, and the reaction particles flow in the downstream direction in contact with a second portion of the flow of reaction gas. In the reactive bed region, the fluidizing gas flow causes fluidizing of the reaction particles to facilitate a chemical reaction between the reaction gas and the reaction particles.

The various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosure will become more apparent from the following detailed description, claims, and accompanying figures.

### BRIEF DESCRIPTION OF THE DRAWINGS

FIG. 1 is a schematic illustration of a reactor system including a reaction assembly according to an example.

FIG. 2 is an illustration of a reaction assembly with reaction particles exhibiting spouting in a reactive bed region according to an example.

FIG. 3 is an illustration of a reaction assembly with reaction particles exhibiting spouting in a reactive bed region according to another example.

FIG. 4 is an illustration of a reaction assembly with reaction particles exhibiting spouting in a reactive bed region according to another example.

FIG. 5 is a cross-sectional perspective view of a portion of the reaction assembly of FIG. 4.

FIG. 6A is a perspective view of a gas acceleration region of the reaction assembly of FIGS. 4-5.

FIG. 6B is a cross-sectional perspective view of the gas acceleration region of FIG. 6A as viewed along the line 6B-6B of FIG. 6A.

FIG. 7A is a perspective view of a gas acceleration region of a reaction assembly according to another example.

FIG. 7B is a cross-sectional perspective view of the gas acceleration region of FIG. 7A as viewed along the line 7B-7B of FIG. 7A.

FIG. 8 is a graph illustrating a relationship between reaction particle size and reaction gas superficial velocity in three different gas-particle regimes according to an example.

FIG. 9 is a graph illustrating the dependence of an expected gas velocity of a reaction gas as a function of the volumetric flow rate of the reaction gas into the moving bed region of a reaction assembly according to an example.

FIG. 10 is a flow chart depicting a method of operating a reactor system according to an example.

### DETAILED DESCRIPTION

### Overview of the Disclosed Technology

The present disclosure relates to a reaction assembly for a reactor system (e.g., for a fluidized bed reactor), and specifically to a counterflow gravity driven system. As discussed in more detail below, the reaction assembly can exhibit different dynamical properties within different regions of the reaction assembly.

The reaction assembly is filled with solid reaction particles and the fluidizing reaction gas is fed from the bottom of the reactor. The reaction particles move down due to gravity, and the reaction gas moves upward due to higher gas pressure at the inlet than the outlet.

In an example, the reaction assembly includes a nozzle installed within a reaction assembly housing to temporarily separate a portion of reaction gas flowing upstream from the reaction particles flowing downstream and accelerating the reaction gas to inject a faster stream of reaction gas into the particle bed upstream of the nozzle. Additionally, the reaction assembly includes a downcomer region surrounding the nozzle that allows the particles to continue moving down without the need of exiting the reactor.

The reaction assembly can operate to create and maintain two differentiable gas-particle regimes within the same vessel in a counterflow fluidized bed reactor. In particular, the reaction assembly can support a fluidized bed regime in one zone where high mixing is required and a moving bed regime in another zone where less mixing is required, all within the same reactor vessel. In some examples, the fluidized bed regime is a spouting fluidized bed regime. The reaction assembly allows the fluidizing reaction gas and the reaction particles to transition between the two differentiable regimes without exiting and reentering the reactor vessel and without requiring any moving parts.

In an example in which the reaction assembly supports a spouting fluidized bed regime, the reaction particles can move down from the top of the reactor and encounter the fast stream of reaction gas coming from the nozzle which spouts the reaction particles upward creating a recirculating motion. The reaction particles then move down on the downcomer region of the apparatus and continue in a moving bed regime in the section of the reactor below the apparatus.

The upcoming reaction gas moves up from the bottom of the reactor. Initially, the reaction gas is in contact with the reaction particles in the moving bed region. A portion of the reaction gas then separates from the reaction particles in a gas acceleration region and gets accelerated before exiting the nozzle and entering a reactive bed region with a high superficial gas velocity (u_{g}).

In this manner, the assemblies, systems, and methods of the present disclosure can enable a system to exhibit continuous operation in a single vessel that includes a region exhibiting thorough mixing and uniform temperature and a different region exhibiting low mixing and a temperature gradient.

The assemblies, systems, and methods of the present disclosure may be particularly relevant to applications in continuous particle-based thermochemical energy storage systems. It is to be understood, however, that the assemblies, systems, and methods of the present disclosure also may be adapted and/or applied to any other suitable applications. For example, the fluidization transition dynamics associated with the nozzle also can be applied to systems such as continuous drying or roasting of grains, enabling a heat recuperation section located below the nozzle. Other applications may include any suitable continuous particle-based processing system, such as those employed in pharmaceutical manufacturing and chemical engineering.

### General Considerations

For purposes of this description, certain aspects, advantages, and novel features of examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

As used herein, the phrase “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, a first direction that is at least substantially parallel to a second direction includes a first direction that is within an angular deviation of 22.5° relative to the second direction and also includes a first direction that is identical to the second direction.

As used herein, the terms “selective” and “selectively,” when modifying an action, movement, configuration, or other activity of one or more components or characteristics of an apparatus, mean that the specific action, movement, configuration, or other activity is a direct or indirect result of one or more dynamic processes, as described herein. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function, but rather that the element, component, and/or other subject matter is specifically selected, created, implemented, utilized, programmed, and/or designed for the purpose of performing the function. It also is within the scope of the present disclosure that elements, components, and/or other recited subject matter that is recited as being adapted to perform a particular function additionally or alternatively may be described as being configured to perform that function, and vice versa. Similarly, subject matter that is recited as being configured to perform a particular function additionally or alternatively may be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); and in yet another example, to both A and B (optionally including other entities). These entities may refer to elements, actions, structures, steps, operations, values, and the like.

As used herein, the phrase “one or more,” in reference to a list of one or more entities, should be understood to mean at least one entity selected from any one or more of the entities in the list of entities, but not necessarily including at least one of each and every entity specifically listed within the list of entities and not excluding any combinations of entities in the list of entities. This definition also allows that entities optionally may be present other than the entities specifically identified within the list of entities to which the phrase “one or more” refers, whether related or unrelated to those entities specifically identified. Thus, as a non-limiting example, “one or more A and B” (or, equivalently, “one or more of A or B,” or, equivalently, “one or more of A and/or B”) may refer, in one embodiment, to at least one, optionally including more than one, A, with no B present (and optionally including entities other than B); in another embodiment, to at least one, optionally including more than one, B, with no A present (and optionally including entities other than A); and in yet another embodiment, to at least one, optionally including more than one, A, and at least one, optionally including more than one, B (and optionally including other entities). In other words, the phrases “one or more,” “at least one,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure. In this manner, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

### Examples of the Disclosed Technology

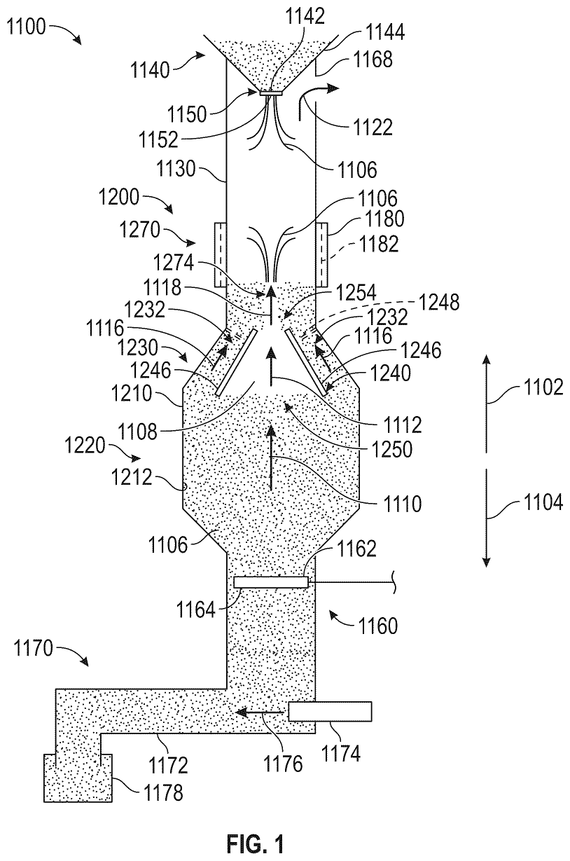

FIG. 1 illustrates an example of a reactor system 1100 including a reaction assembly 1200 according to the present disclosure. As described in more detail herein, the reaction assembly 1200 generally is configured to facilitate a chemical reaction between a reaction gas 1108 and reaction particles 1106 within the reactor system 1100.

In particular, the present disclosure generally relates to examples in which the reaction particles 1106 and the reaction gas 1108 undergo an exothermic chemical reaction with one another and in which the reaction assembly 1200 and/or the reactor system 1100 are configured to extract heat energy from the exothermic reaction. As a more specific example, the reaction particles 1106 can include metal oxide particles, such as magnesium manganese oxide particles, and the reaction gas 1108 can include and/or be an oxidizing agent such as air and/or oxygen. Accordingly, the reaction assembly 1200 can be configured to facilitate an oxidation reaction between the reaction particles 1106 and the reaction gas 1108 to generate usable heat energy that is extracted by the reactor system 1100.

While the present disclosure generally relates to examples in which the reaction particles 1106 and the reaction gas 1108 undergo an exothermic chemical reaction with one another, this is not required of all examples. It also is within the scope of the present disclosure that the systems and/or assemblies disclosed herein can promote and/or facilitate any of a variety of physical and/or chemical reactions and/or interactions between the reaction particles 1106 and the reaction gas 1108. Examples of such interactions and/or processes may include exothermic chemical reactions, endothermic chemical reactions, redox reactions, calcination processes, roasting processes, heat transfer processes, etc. Accordingly, in various examples, the reactor system 1100 additionally or alternatively may be referred to as a system 1100 and/or the reaction assembly 1200 additionally or alternatively may be referred to as an assembly 1200. Similarly, the reaction particles 1106 additionally or alternatively may be referred to as particles 1106 and/or the reaction gas 1108 additionally or alternatively may be referred to as a gas 1108. Other components named and/or described herein with reference to a reactor and/or reactive processes similarly may be understood as referring to and/or encompassing analogous components that are not necessarily used in conjunction with a reactor and/or with reactive processes.

The reactor system 1100 and/or the reaction assembly 1200 can be configured to be used with reaction particles 1106 of any suitable form. For example, the reaction particles 1106 may include and/or be spherical particles and/or non-spherical particles (e.g., pellets). In some examples, the reaction particles 1106 can be characterized by a characteristic particle diameter of each reaction particle 1106 and/or by an average of such characteristic particle diameters. In such examples, the characteristic particle diameter can be measured in any suitable manner, such as the diameter of the smallest sphere that can circumscribe each reaction particle 1106 and/or the diameter of a sphere of the same mass and density as each reaction particle 1106. As example, each reaction particle 1106 can have an average characteristic particle diameter that is at least 0.1 millimeters (mm), at least 0.5 mm, at least 1 mm, at least 5 mm, at least 10 mm, at least 15 mm, at most 20 mm, at most 12 mm, at most 7 mm, at most 2 mm, at most 0.7 mm, at most 0.2 mm, 0.1-1 mm, 0.5-5 mm, 1-10 mm, 5-15 mm, and/or 10-20 mm.

The reaction particles 1106 additionally or alternatively can be characterized by an average particle density of each particle. As examples, the average particle density can be at least 500 kilograms per cubic meter (kg/m³), at least 1000 kg/m³, at least 1500 kg/m³, at least 2000 kg/m³, at most 2500 kg/m³, at most 1700 kg/m³, at most 1200 kg/m³, at most 700 kg/m³, 500-1500 kg/m³, 1000-2000 kg/m³, and/or 1500-2500 kg/m³.

As shown in FIG. 1, the reactor system 1100 can include a reactor enclosure 1130, a reaction particle inlet 1142 configured to introduce the reaction particles 1106 into the reactor enclosure 1130, and a reaction gas inlet 1162 configured to introduce a flow of the reaction gas 1108 into the reactor enclosure 1130. In particular, the reactor system 1100 is configured such that the reaction particles 1106 flow through the reactor enclosure 1130 in a downstream direction 1104 while the reaction gas 1108 flows through the reactor enclosure 1130 in an upstream direction 1102 that is opposite to the downstream direction 1104. In various examples, the reactor enclosure 1130 additionally or alternatively may be referred to as an enclosure 1130, the reaction particle inlet 1142 additionally or alternatively may be referred to as a particle inlet 1142, and/or the reaction gas inlet 1162 additionally or alternatively may be referred to as a gas inlet 1162.

As used herein, positional and/or directional terms such as “down,” “below,” “under,” “up,” “above,” “over,” and the like generally refer to directions relative to the upstream direction 1102 and/or the downstream direction 1104 as illustrated in FIG. 1. For example, a first component that is displaced from a second component along the downstream direction 1104 may be described as being positioned below the second component. It is to be understood, however, that such descriptions are provided for clarity and are non-limiting.

The reaction assembly 1200 is disposed between the reaction particle inlet 1142 and the reaction gas inlet 1162. The reaction assembly 1200 includes a reaction assembly housing 1210 configured to support a flow of the reaction gas 1108 in the upstream direction 1102 and a flow of the reaction particles 1106 in the downstream direction 1104. The reaction assembly housing 1210 can include and/or be a portion of the reactor enclosure 1130 or can include and/or be a separate structure disposed within the reactor enclosure 1130. In various examples, the reaction assembly housing 1210 additionally or alternatively may be referred to as an assembly housing 1210.

As described herein, the reactor system 1100 and/or the reaction assembly 1200 are configured such that the reaction particles 1106 generally flow in the downstream direction 1104, while the reaction gas 1108 generally flows in the upstream direction 1102. In particular, while any given unit (e.g., particle) of the reaction particles 1106 can flow in a direction other than the downstream direction 1104 at a given time, a time-averaged flow of the reaction particles 1106 generally is directed in the downstream direction 1104. This downstream flow of the reaction particles 1106 may be attributed to the force of gravity upon the reaction particles 1006.

Similarly, while any given unit (e.g., molecule or localized volume thereof) of the reaction gas 1108 can flow in a direction other than the upstream direction 1102 at a given time, a time-averaged flow of the reaction gas 1108 generally is directed in the upstream direction 1102. This upstream flow of the reaction gas 1108 may be attributed to a decreased pressure of the reaction gas 1108 in an upstream portion of the reactor system 1100 relative to a downstream portion of the reactor system 1100.

Operation of the reaction assembly 1200 can be described with reference to regions thereof that support distinct gas-particle dynamics regimes. In particular, and as shown in FIG. 1, the reaction assembly 1200 includes a moving bed region 1220, a gas acceleration region 1230 upstream of the moving bed region 1220, and a reactive bed region 1270 upstream of the gas acceleration region 1230. As described in more detail below, the reaction assembly 1200 can be configured such that the reaction particles 1106 flow from the reactive bed region 1270 to the moving bed region 1220 only via the gas acceleration region 1230. In some examples, the moving bed region 1220, the gas acceleration region 1230, and the reactive bed region 1270 may correspond to non-overlapping regions. Stated differently, the moving bed region 1220, the gas acceleration region 1230, and the reactive bed region 1270 may be understood as representing distinct regions of the reaction assembly 1200 that are immediately adjacent to one another.

During operative use of the reaction assembly 1200, a moving bed gas flow 1110 of the reaction gas 1108 flows in contact with the reaction particles 1106 within the moving bed region 1220. Upstream of the moving bed region 1220, a portion of the flow of the reaction gas 1108 is accelerated within the gas acceleration region 1230 to produce a fluidizing gas flow 1118. The fluidizing gas flow 1118 causes fluidizing of the reaction particles 1106 within the reactive bed region 1270 to facilitate the chemical reaction and/or other interaction between the reaction gas 1108 and the reaction particles 1106 within the reactive bed region 1270. The reactive bed region 1270 additionally or alternatively may be referred to as a fluidized bed region 1270 and/or as a gas-particle interaction region.

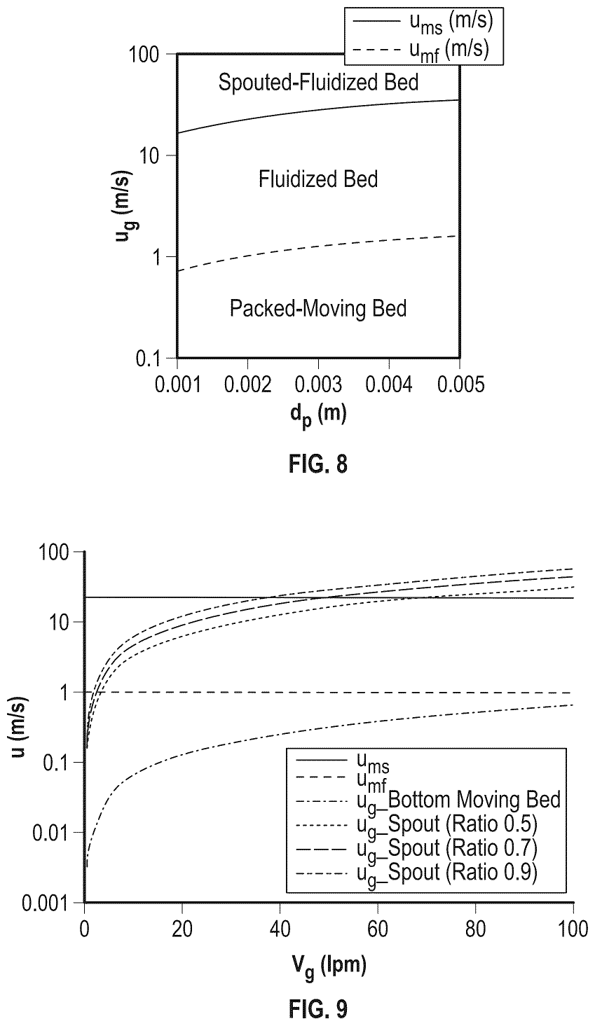

Within the moving bed region 1220, the superficial velocity of the moving bed gas flow 1110 may be sufficiently low to avoid fluidization of the reaction particles 1106 within the moving bed region 1220. In particular, and as discussed in more detail below with reference to FIG. 8, the superficial velocity of the moving bed gas flow 1110 may be lower than a minimum fluidizing gas velocity corresponding to the configuration of the reaction particles 1106. Accordingly, the gas-particle dynamics within the moving bed region 1220 can be characterized by a low degree of mixing.

The temperature of the reaction particles 1106 within the moving bed region 1220 can exhibit a controlled thermal gradient. For example, the downwardly-flowing reaction particles 1106 that enter the moving bed region 1220 from the reactive bed region 1270 may have a very high temperature corresponding to the exothermic reaction with the reaction gas 1008. These high-temperature reaction particles 1106 are cooled by the upwardly-flowing reaction gas 1108 within the moving bed region 1220 such that the temperature of the reaction particles 1106 and/or of the reaction gas 1108 decreases along the downstream direction 1104. As a result, the reaction particles 1106 are relatively cool upon exiting the moving bed region 1220. Such a configuration thus relaxes the requirement that portions of the reactor system 1100 and/or the reaction assembly 1200 in and/or downstream of the moving bed region 1220 to be formed of materials that can withstand the high temperatures associated with the exothermic chemical reaction. Accordingly, this controlled cooling of the reaction particles 1106 within the moving bed region 1220 can allow for the use of relatively inexpensive materials in the construction of the reactor system 1100 and/or the reaction assembly 1200 downstream of the moving bed region 1220.

Within the reactive bed region 1270, by contrast, the superficial velocity of the fluidizing gas flow 1118 may be sufficiently high to cause fluidizing and/or spouting of the reaction particles 1106 within the path of the fluidizing gas flow 1118. In particular, and as discussed in more detail below with reference to FIG. 8, the superficial velocity of the fluidizing gas flow 1118 may be greater than a minimum fluidizing gas velocity corresponding to the configuration of the reaction particles 1106. In such examples, the fluidizing gas flow 1118 can operate to fluidize the reaction particles 1106 within the reactive bed region 1270.

In some examples, the superficial velocity of the fluidizing gas flow 1118 also may be greater than a minimum spouting gas velocity corresponding to the configuration of the reaction particles 1106. In such examples, the fluidizing gas flow 1118 can operate to yield spouting of the reaction particles 1106 within the reactive bed region 1270. In such examples, the fluidizing gas flow 1118 also may be referred to as a spouting gas flow 1118, and/or the reactive bed region 1270 also may be referred to as a spouted bed region 1270.

Accordingly, the gas-particle dynamics within the reactive bed region 1270 can be characterized by a high degree of mixing, with the temperature of the reaction particles 1106 and/or of the reaction gas 1108 being at least substantially uniform as the chemical reaction between the reaction particles 1106 and the reaction gas 1108 takes place.

The present disclosure generally relates to examples in which the reaction gas 1108 causes spouting of the reaction particles 1106 within the reactive bed region 1270. Stated differently, the present disclosure generally relates to examples in which the fluidizing gas flow 1118 is a spouting gas flow 1118 and in which the reactive bed region 1270 is a spouted bed region 1270. It is to be understood, however, that the descriptions and examples of the present disclosure also may pertain (as applicable) to examples in which the reaction gas 1108 fluidizes the reaction particles 1106 upstream of the gas acceleration region 1230 without yielding spouting dynamics in this region. In such examples, the fluidizing of the reaction particles 1106 with the reaction gas 1108 can promote and/or facilitate the chemical reaction within this region in a similar manner as in examples characterized by spouting dynamics.

Accordingly, any descriptions herein of a reactive bed region (e.g., the reactive bed region 1270) may be understood as pertaining to any suitable examples in which the reaction gas 1108 fluidizes the reaction particles 1106. Such examples include (but are not limited to) examples in which the reaction gas 1108 yields spouting dynamics. Similarly, any descriptions herein of a fluidizing gas flow (e.g., the fluidizing gas flow 1118) may be understood as pertaining to any suitable examples in which the reaction gas 1108 flows with sufficient velocity to fluidize the reaction particles 1106. Such examples include (but are not limited to) examples in which the superficial velocity of the fluidizing gas flow is greater than a minimum fluidizing velocity and/or a minimum spouting gas velocity.

In this manner, any descriptions herein of a reactive bed region (e.g., the reactive bed region 1270) may be understood as additionally or alternatively pertaining to examples in which the referenced region is a spouted bed region (e.g., the spouted bed region 1270) in which a reaction gas fluidizes reaction particles to yield spouting dynamics. Similarly, any descriptions herein of a fluidizing gas flow (e.g., the fluidizing gas flow 1118) may be understood as additionally or alternatively pertaining to examples in which the referenced gas flow is a spouting gas flow (e.g., the spouting gas flow 1118) that fluidizes reaction particles to yield spouting dynamics. In the present disclosure, spouting dynamics may be understood as representing an example (e.g., a subset) of fluidizing dynamics.

In some examples, the reaction assembly 1200 additionally can include one or more pre-heaters configured to pre-heat the reaction particles 1106 within and/or upstream of the reactive bed region 1270. Such pre-heaters can operate to further facilitate the exothermic chemical reaction between the reaction particles 1106 and the reaction gas 1108. When present, the pre-heaters can take any suitable form, such as conductive heaters placed in thermal contact with the reactor enclosure 1130.

FIG. 1 represents an example in which the reactive bed region 1270 is a spouted bed region and in which the fluidizing gas flow 1118 is a spouting gas flow that causes spouting of the reaction particles 1106. As shown in FIG. 1, spouting of the reaction particles 1106 within the reactive bed region 1270 can be characterized and/or represented by the formation of one or more particle spouts 1274. In particular, each particle spout 1274 can refer to a localized region of the reactive bed region 1270 that is at least substantially free of reaction particles 1106 due to being displaced by the fluidizing gas flow 1118, and/or can refer to the corresponding reaction particles 1106 that are flung upstream by the fluidizing gas flow 1118. In some examples, the spouting gas flow 1118 can operate to generate a series of particle spouts 1274, such as in the form of a series of bubbles of reaction gas 1108 formed in the reaction particles 1106. Additionally or alternatively, in some example, the fluidizing gas flow 1118 can operate to generate a continuous particle spout 1274.

The reaction assembly 1200 can be configured to produce the fluidizing gas flow 1118 in any suitable manner. For example, and as shown in FIG. 1, the gas acceleration region 1230 can include a nozzle 1240 configured to accelerate a portion of the reaction gas 1108 and one or more downcomer regions 1232 defined between the nozzle 1240 and the reaction assembly housing 1210. As the moving bed gas flow 1110 of the reaction gas 1108 flows into the gas acceleration region 1230, a portion of the reaction gas 1108 can flow into a nozzle inlet 1250 of the nozzle 1240 and can be accelerated by the nozzle 1240 to produce the fluidizing gas flow 1118 and/or the spouting gas flow 1118 as described herein. The portion of the flow of reaction gas 1108 that flows into the nozzle 1240 and that is accelerated by the nozzle 1240 can be referred to as an accelerating gas flow 1112. The accelerating gas flow 1112 is then expelled from a nozzle outlet 1254 of the nozzle 1240 to produce the fluidizing gas flow 1118. As shown in FIG. 1, a second portion of the reaction gas 1108 flowing upstream into the gas acceleration region 1230 flows upstream through the downcomer region(s) 1232 as one or more downcomer gas flows 1116.

During the spouting of the reaction particles 1106 produced by the fluidizing gas flow 1118, the reaction particles 1106 positioned near and/or above the nozzle outlet can be driven upwards by the fluidizing gas flow 1118, thereby creating a spout of reaction particles 1106 that react with the reaction gas 1108. The spouted reaction particles 1106 can then return to the bed of reaction particles 1106, where such particles can be recirculated into the spout or can flow into the moving bed region 1220.

In some examples, some reaction particles 1106 may be recirculated through the fluidizing gas flow 1118 numerous times, while some other reaction particles 1106 may flow into the downcomer region(s) 1232 without interacting with the fluidizing gas flow 1118. Such a nonuniformity in the residence time distribution of the reaction particles 1106 within the reactive bed region 1270 can result in certain reaction particles 1106 interacting with the fluidizing gas flow 1118 even after a release of the chemical energy stored therein and/or in certain other reaction particles 1106 exiting the reactive bed region 1270 without releasing their stored chemical energy.

Accordingly, it may be desirable to configure the reaction assembly 1200 such that the residence time distribution of the reaction particles 1106 within the reactive bed region 1270 is at least substantially uniform. This can be accomplished, for example, via a suitable structural configuration of the reaction assembly housing 1210, of the nozzle 1240, and/or of the downcomer regions 1232, such as to direct reaction particles 1106 toward the nozzle outlet 1254. Additionally or alternatively, the uniformity of the residence time distribution may be enhanced with a series of baffles and/or partitions positioned within the reactive bed region 1270 to at least partially direct a flow of the reaction particles 1106 within the reactive bed region 1270. For example, the reaction assembly 1200 can include one or more baffles extending within the reactive bed region 1270 (e.g., along the downstream direction 1104) upstream of the nozzle 1240 in a configuration that directs and/or constraints the reaction particles 1106 to follow a tortuous and/or circuitous path through the reactive bed region 1270 and/or to the downcomer regions 1232.

As shown in FIG. 1, the reaction assembly 1200 can be configured such that the reaction particles 1106 that flow from the reactive bed region 1270 to the moving bed region 1220 do so only via the downcomer region(s) 1232. For example, the reaction assembly 1200 can be configured such that a nozzle interior region 1244 of the nozzle 1240 is at least partially free of reaction particles 1106 during operative use of the reaction assembly 1200. In particular, the nozzle 1240 can operate to collect and accelerate the reaction gas 1108 such that the accelerated reaction gas 1108 restricts reaction particles 1106 from entering the nozzle interior region 1244 via the nozzle outlet 1254 and/or such that reaction particles 1106 that enter the nozzle interior region 1244 are expelled from the nozzle 1240 via the nozzle outlet 1254.

The nozzle 1240 can be supported within the reaction assembly 1200 in any suitable manner. For example, the nozzle 1240 can be supported by and/or coupled to (e.g., directly coupled to) the reaction assembly housing 1210. As a more specific example, the nozzle 1240 can include one or more nozzle plates 1246 that are fixedly coupled to an interior surface 1212 of the reaction assembly housing 1210. In such examples, each nozzle plate 1246 can be coupled to each of a pair of opposed walls or portions of the interior surface 1212 such that the nozzle plates 1246 collectively form the nozzle 1240 in the manner shown in FIG. 1. In such examples, each nozzle plate 1246 can be coupled to the reaction assembly housing 1210 in any suitable manner, such as by welding and/or by mechanical fastener(s). While FIG. 1 illustrates each nozzle plate 1246 as being flat and/or planar, this is not required of all examples, and it additionally is within the scope of the present disclosure that each nozzle plate 1246 can be at least partially curved and/or otherwise non-planar.

Additionally or alternatively, and as shown in dashed lines in FIG. 1, the reaction assembly 1200 can include one or more nozzle supports 1248 extending between the nozzle 1240 and the reaction assembly housing 1210 (e.g., the interior surface 1212 thereof) to support the nozzle within the gas acceleration region 1230. In some such examples, the nozzle 1240 can have a shape that is rotationally symmetric about a central axis thereof, such as a frusto-conical shape, with a full circumference of the nozzle 1240 being spaced apart from the interior surface 1212 of the reaction assembly housing 1210.

Each downcomer region 1232 can be formed and/or defined in any of a variety of manners. In various examples, each downcomer region 1232 is defined by a nozzle outer surface 1242 of the nozzle 1240 and the interior surface 1212 of the reaction assembly housing 1210. In an example in which the nozzle 1240 includes a pair of nozzle plates 1246 affixed to opposite walls of the interior surface 1212, the gas acceleration region 1230 can be described as including two spaced-apart downcomer regions 1232 as shown in FIG. 1. Alternatively, in an example in which the nozzle 1240 includes a rotationally symmetric structure supported within the reaction assembly housing 1210 by nozzle supports 1248, the gas acceleration region 1230 can be described as including a single downcomer region 1232 circumferentially surrounding the nozzle 1240.

Each downcomer region 1232 can be configured (e.g., shaped and/or dimensioned) to support opposed flows of the reaction particles 1106 and of the reaction gas 1108 as described herein. For example, each downcomer region 1232 can be configured such that the downcomer gas flow 1116 of the reaction gas 1108 flows upstream with a velocity that is sufficiently small to allow the reaction particles 1106 to flow through the downcomer region 1232 in the downstream direction 1104.

The reaction assembly housing 1210 can have any suitable shape and/or form. In some examples, the reaction assembly housing 1210 can be at least partially cylindrical and/or can be circular in cross-section (e.g., as viewed perpendicular to the downstream direction 1104). In other examples, at least a portion of the reaction assembly housing 1210 can be rectangular in cross-section (e.g., as viewed perpendicular to the downstream direction 1104).

In examples in which the reaction particles 1106 and the reaction gas 1108 undergo an exothermic chemical reaction, the reactor system 1100 can be configured to extract heat energy from the exothermic chemical reaction in any suitable manner. For example, and as shown in FIG. 1, the reactor system 1100 can include a heat exchanger 1180 that is configured to bring a process fluid 1182 into thermal contact with the reaction assembly 1200. In particular, the heat exchanger 1180 may be configured to convey heat energy from the reaction assembly housing 1210 (e.g., within the reactive bed region 1270) to the process fluid 1182 such that the process fluid 1182 can convey the heat energy away from the reaction assembly housing 1210 for energy recovery and/or use.

The reactor system 1100 can be configured to introduce the reaction particles 1106 into the reactor enclosure 1130 via the reaction particle inlet 1142 in any suitable manner. For example, the reaction particle inlet 1142 can include and/or be an orifice through which the reaction particles 1106 are introduced into the reactor enclosure 1130.

Additionally or alternatively, the reactor system 1100 can include a particle feed subassembly 1140 configured to introduce the reaction particles 1106 into the reactor enclosure 1130 via the reaction particle inlet 1142. In such examples, the particle feed subassembly 1140 can include the reaction particle inlet 1142. As a more specific example, and as shown in FIG. 1, the particle feed subassembly 1140 can include a hopper 1144 configured to direct the reaction particles 1106 into the reactor enclosure 1130, such as via an orifice thereof. In some such examples, the hopper 1144 can be configured to introduce the reaction particles 1106 into the reactor enclosure 1130 passively. For example, a rate at which the reaction particles 1106 are introduced into the reactor enclosure 1130 can be related to a diameter of the orifice of the hopper 1144.

Additionally or alternatively, in some examples, the particle feed subassembly 1140 can include an active feed mechanism 1150 configured to regulate a feed rate at which the reaction particles 1106 are introduced into the reactor enclosure 1130. In such examples, the active feed mechanism 1150 can include and/or be any suitable mechanism, such as a controlled gate 1152 configured to be selectively opened and closed to permit and restrict ingress of the reaction particles 1106 into the reactor enclosure 1130. As another example, the active feed mechanism 1150 can include and/or be a pulsed-gas particle flow controller configured to at least partially control a rate at which the reaction particles 1106 flow toward and/or into the reactor enclosure 1130 using a pulsed gas flow.

As discussed above, the reaction assembly 1200 can support a continuous flow of the reaction particles 1106 downstream through the reactive bed region 1270, the gas acceleration region 1230, and the moving bed region 1220. To support this continuous flow, it may be desirable to remove the reaction particles 1106 from the reactor enclosure 1130 while the chemical reaction takes place within the reactive bed region 1270.

The reactor system 1100 can include any suitable features for removal of the reaction particles 1106 from the reactor enclosure 1130. For example, and as shown in FIG. 1, the reactor system 1100 can include a particle disposal subassembly 1170 disposed downstream of the moving bed region 1220 and configured to remove the reaction particles 1106 from the reactor enclosure 1130. In the example of FIG. 1, the particle disposal subassembly 1170 includes a waste particle conduit 1172 configured to convey the reaction particles 1106 away from the reactor enclosure 1130 as well as a waste particle receptacle 1178 configured to receive and store the reaction particles 1106 that are removed from the reactor enclosure 1130.

The particle disposal subassembly 1170 can be configured to restrict the reaction gas 1108 from exiting the reactor enclosure 1130 via the particle disposal subassembly 1170. For example, to ensure that the reaction gas 1108 flows in the upstream direction 1102 through the moving bed region 1220, the gas acceleration region 1230, and the reactive bed region 1270, the particle disposal subassembly 1170 may be configured to restrict and/or block a flow the reaction gas 1108. In some examples, this can be accomplished at least in part by sealing the waste particle receptacle 1178 against the waste particle conduit 1172. Additionally or alternatively, the particle disposal subassembly 1170 can include a gate and/or door (and/or a series thereof) that selectively seals off the waste particle conduit 1172, such as to enable the waste particle receptacle 1178 to be removed and emptied and/or replaced without interrupting continuous operation of the reactor system 1100. In such examples, the waste particle conduit 1172 can allow for an accumulation of the reaction particles 1106 therein while the waste particle receptacle 1178 is emptied and/or replaced.

In some examples, and as shown in FIG. 1, the particle disposal subassembly 1170 additionally or alternatively can include a pulsed-gas particle conveyor 1174 configured to convey the reaction particles 1106 through the waste particle conduit 1172 (e.g., toward the waste particle receptacle 1178). In such examples, the pulsed-gas particle conveyor 1174 can be configured to generate a pulsed gas flow 1176 that drives the reaction particles 1106 through the waste particle conduit 1172 and/or toward the waste particle receptacle 1178. In such examples, controlling the frequency of the pulses of the pulsed gas flow 1176 can operate to control the rate at which the reaction particles 1106 are driven through the waste particle conduit 1172, which in turn can control the rate at which the reaction particles 1106 are removed from the reactor enclosure 1130. In some examples, the pulsed-gas particle conveyor 1174 additionally or alternatively may be referred to as (or as being a component of) an L-valve assembly.

The reactor system 1100 can be configured to introduce the reaction gas 1108 into the reactor enclosure 1130 via the reaction gas inlet 1162 in any suitable manner. For example, and as shown in FIG. 1, the reactor system 1100 can include a reaction gas distributor 1160 configured to introduce the reaction gas 1108 into the reactor enclosure 1130 via the reaction gas inlet 1162. In some examples, the reaction gas distributor 1160 can be configured to regulate a flow rate at which the reaction gas 1108 is introduced into the reactor enclosure 1130 (e.g., via a gas regulator). In various examples, the reaction gas distributor 1160 additionally or alternatively may be referred to as a gas distributor 1160.

The reaction gas distributor 1160 can include and/or be any suitable structure and/or mechanism. For example, the reaction gas distributor 1160 can include and/or be a sparger 1164 disposed within the reactor enclosure 1130. The sparger 1164 can include the reaction gas inlet 1162, such as in the form of a collection of openings formed in one or more conduits extending into the reactor enclosure 1130. Such conduits can be arranged in a grid pattern, a ring pattern, and/or any other pattern such that the reaction particles 1106 may flow past the sparger 1164 in the downstream direction 1104 as the sparger 1164 introduces the reaction gas 1108 into the reactor enclosure 1130.

Additionally or alternatively, in some examples, the reaction gas distributor 1160 can include and/or be a perforated plate disposed within the reactor enclosure 1130 and including the reaction gas inlet 1162. In some such examples, the perforated plate may not be configured to permit flow of the reaction particles 1106 therethrough and instead may be positioned (e.g., at a downstream end of the reactor enclosure 1130) such that a flow of the reaction particles 1106 is not substantially impeded by the presence of the perforated plate.

In some examples, and as shown in FIG. 1, the reactor system 1100 can include a reaction gas outlet 1168 positioned upstream of the reactive bed region 1270 and configured to exhaust an exhaust gas flow 1122 of the reaction gas 1108 from the reactor enclosure 1130. Additionally or alternatively, in some examples, at least a portion of the reaction gas 1108 can exit the reactor enclosure 1130 via the reaction particle inlet 1142.

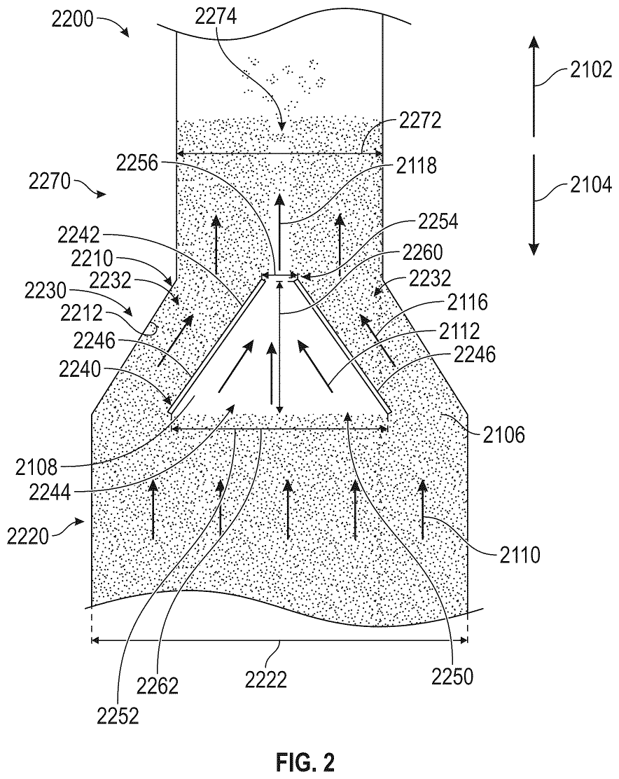

FIG. 2 illustrates aspects of a reaction assembly 2200. The reaction assembly 2200 of FIG. 2 is at least substantially similar to the reaction assembly 1200 of FIG. 1 and may be described as representing an example of the reaction assembly 1200 of FIG. 1. Accordingly, like reference numerals are used to label like components in FIGS. 1-2. Specifically, unless otherwise stated, all illustrated components of FIG. 2, labeled or unlabeled, can share any suitable features, characteristics, attributes, etc. with the corresponding components illustrated in FIG. 1. For those components labeled in FIG. 2, components labeled with a reference numeral of the form “2XXX” are intended to correspond with the components labeled with a reference numeral of the form “1XXX” in FIG. 1. For example, the nozzle 2240 of FIG. 2 corresponds to, and may be at least substantially identical to, the nozzle 1240 of FIG. 1. Accordingly, descriptions herein of components shown in FIG. 2 also may be understood as pertaining to corresponding components shown in FIG. 1 and/or in any other figure herein.

The nozzle 2240 can be configured to accelerate the reaction gas 2108 such that the accelerating gas flow 2112 exits the nozzle 2240 with a sufficiently high velocity to produce spouting of the reaction particles 2106 as the fluidizing gas flow 2118, which in this example is a spouting gas flow. The acceleration of the reaction gas 2108 by the nozzle 2240 can be related to any of a variety of geometrical properties of the nozzle 2240. For example, and as shown in FIG. 2, the nozzle 2240 can extend between and include the nozzle inlet 2250 and the nozzle outlet 2254.

The nozzle outlet 2254 generally is smaller in one or more dimensions than the nozzle inlet 2250. For example, and as shown in FIG. 2, the nozzle inlet 2250 can be characterized by a nozzle inlet cross-sectional area 2252, while the nozzle outlet 2254 can be characterized by a nozzle outlet cross-sectional area 2256 that is smaller than the nozzle inlet cross-sectional area 2252. While FIG. 2 illustrates each of the nozzle inlet cross-sectional area 2252 and the nozzle outlet cross-sectional area 2256 with reference to a linear dimension, it is to be understood that each of these quantities represents a two-dimensional area measurement, such as may be measured in a plane extending perpendicular to the upstream direction 2102 and/or the downstream direction 2104.

In some examples, a degree to which the nozzle 2240 operates to accelerate the reaction gas 2108 is related to a relationship between the nozzle inlet cross-sectional area 2252 and the nozzle outlet cross-sectional area 2256. For example, configuring the nozzle 2240 such that the nozzle outlet cross-sectional area 2256 is relatively small in proportion to the nozzle inlet cross-sectional area 2252 can enhance the degree to which the reaction gas 2108 is accelerated by the nozzle 2240.

The nozzle inlet cross-sectional area 2252 can be related to the nozzle outlet cross-sectional area 2256 in any of a variety of manners. As examples, a ratio of the nozzle inlet cross-sectional area 2252 to the nozzle outlet cross-sectional area 2256 can be at least 20:1, at least 40:1 at least 60:1, at least 80:1, at least 100:1, at least 120:1 at most 150:1, at most 110:1, at most 90:1, at most 70:1, at most 50:1, at most 30:1, 20:1-60:1, 40:1-80:1, 60:1-100:1, 80:1-120:1, and/or 100:1-150:1.

Operation of the nozzle 2240 also can be characterized with reference to a geometrical relationship between the nozzle 2240 and the reaction assembly housing 2210 surrounding the nozzle 2240. For example, the reaction assembly housing 2210 can be characterized by a moving bed region cross-sectional area 2222, such as may be measured in the plane in which the nozzle inlet cross-sectional area 2252 is measured. The nozzle inlet cross-sectional area 2252 may be a sufficiently high proportion of the moving bed region cross-sectional area 2222 to ensure that the nozzle 2240 collects a sufficiently high proportion of the reaction gas 2108 to produce fluidizing and/or spouting dynamics with the reactive bed region 2270. The nozzle inlet cross-sectional area 2252 also may be a sufficiently high proportion of the moving bed region cross-sectional area 2222 to ensure that the downcomer gas flows 2116 flow with sufficiently low velocity to avoid driving the reaction particles 2106 upstream within the downcomer regions 2232.

Alternatively, the nozzle inlet cross-sectional area 2252 may be a sufficiently small proportion of the moving bed region cross-sectional area 2222 to ensure that the reaction particles 2106 can flow downstream between the nozzle 2240 and the reaction assembly housing 2210 without causing particle entrainment, particle blockage, and/or particle bridging. Stated differently, the shapes and/or sizes of the reaction particles 2106 may restrict the nozzle inlet cross-sectional area 2252 from being increased arbitrarily, as the structure of these particles may operate to block and/or impede flow between the nozzle 2240 and the reaction assembly housing 2210 if these structures are not separated by a sufficient distance to allow for free flow of the reaction particles 2106.

As more specific examples, a ratio of the nozzle inlet cross-sectional area 2252 to the moving bed region cross-sectional area 2222 can be at least 0.3:1, at least 0.5:1, at least 0.7:1, at most 0.8:1, at most 0.6:1, at most 0.4:1, 0.3:1-0.7:1, and/or 0.5:1-0.8:1. In some examples, it may be desirable to configure the ratio of the nozzle inlet cross-sectional area 2252 to the moving bed region cross-sectional area 2222 to be at least 0.7, such as to ensure that the nozzle inlet 2250 captures a sufficient proportion of the reaction gas 2108 to generate the fluidizing gas flow 2118 while ensuring that the downcomer gas flow 2116 is sufficiently small to allow for free flow of the reaction particles 2106 through the downcomer regions(s) 2232 in the downstream direction 2104. In some examples, the ratio of the nozzle inlet cross-sectional area 2252 to the moving bed region cross-sectional area 2222 additionally or alternatively may be referred to as an acceleration ratio, a compression ratio, and/or a diversion ratio.

Each downcomer region 2232 additionally or alternatively can be characterized by a hydraulic diameter, defined as four times the ratio of the cross-sectional area of the downcomer region 2232 to the wetted perimeter of the cross-section of the downcomer region 2232. In particular, in some examples, it may be desirable to configure each downcomer region 2232 such that the hydraulic diameter thereof is approximately 10 times the characteristic particle diameter of the reaction particles 2106.

In some examples, the reaction assembly housing 2210 is tapered within the gas acceleration region 2230. For example, and as shown in FIG. 2, the reaction assembly housing 2210 also can be characterized by a reactive bed region cross-sectional area 2272 within the reactive bed region 2270, and the moving bed region cross-sectional area 2222 can be greater than the reactive bed region cross-sectional area 2722. Similar to the moving bed region cross-sectional area, the reactive bed region cross-sectional area 2272 can be measured in a plane extending perpendicular to the upstream direction 2102 and/or to the downstream direction 2104.

And as shown in FIG. 2, a configuration of the nozzle 2240 can be characterized with reference to a nozzle height 2260 of the nozzle 2240. In particular, the nozzle height 2260 can be measured between the nozzle inlet 2250 and the nozzle outlet 2254 along the upstream direction 2102 and/or the downstream direction 2104. The nozzle height 2260 can be characterized with reference to one or more other linear dimensions of the nozzle 2240, such as a nozzle maximum width 2262. In particular, the nozzle maximum width 2262 can correspond to a maximum linear dimension of the nozzle 2240 along a direction perpendicular to the upstream direction 2102 and the downstream direction 2104. In the example of FIG. 2, the nozzle maximum width 2262 is measured in the same plane in which the nozzle inlet cross-sectional area 2252 is measured.

In general, configuring the nozzle 2240 such that the nozzle height 2260 is relatively large relative to the nozzle maximum width 2262 can facilitate producing a pressure drop across the nozzle 2240 that is sufficiently low to allow the reaction gas 2108 to enter the nozzle inlet 2250 freely. A ratio of the nozzle height 2260 to the nozzle maximum width 2262 can assume any of a variety of values, examples of which include at least 0.2:1, at least 0.25:1, at least 0.33:1, at least 0.5:1, 1:1, at least 2:1, at least 3:1 at least 4:1, at most 5:1, at most 4.5:1, at most 3.5:1, at most 2.5:1, at most 1.5:1, at most 0.66:1, at most 0.4:1, at most 0.29:1, at most 0.22:1, 0.2:1-0.33:1, 0.25:1-0.5:1, 0.33:1-1:1, 0.5:1-2:1, 1:1-3:1, 2:1-4:1, and/or 3:1-5:1.

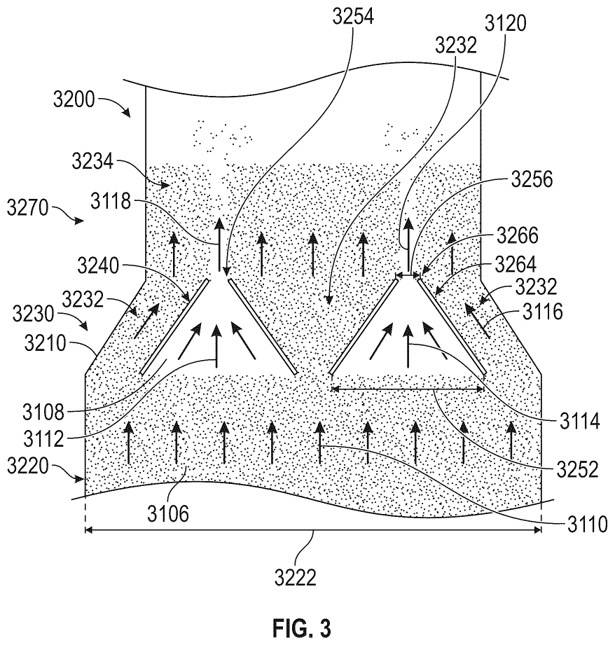

While the present disclosure generally relates to examples in which the gas acceleration region 2230 includes a single nozzle 2242, this is not required, and it additionally is within the scope of the present disclosure that the gas acceleration region 2230 can include any suitable number of nozzles 2242. As an example. FIG. 3 illustrates another example of a reaction assembly 3300. The reaction assembly 3300 of FIG. 3 is substantially similar to the reaction assembly 2200 of FIG. 2 and the reaction assembly 1200 of FIG. 1 with the exception that the gas acceleration region 3230 of FIG. 3 includes a first nozzle 3240 and a second nozzle 3264. In such examples, the reaction assembly 3200 can be described as including a nozzle subassembly 3234 that includes the first nozzle 3240 and the second nozzle 3264 and/or any additional nozzles.

Like reference numerals are used to label like components in FIGS. 1-3. Specifically, unless otherwise stated, all illustrated components of FIG. 3, labeled or unlabeled, can share any suitable features, characteristics, attributes, etc. with the corresponding components illustrated in FIGS. 1-2. For those components labeled in FIG. 3, components labeled with a reference numeral of the form “3XXX” are intended to correspond with the components labeled with a reference numeral of the form “1XXX” in FIG. 1 and/or with the components labeled with a reference numeral of the form “2XXX” in FIG. 2. Accordingly, descriptions herein of components shown in FIG. 3 also may be understood as pertaining to corresponding components shown in FIGS. 1-2 and/or in any other figure herein.

In an example in which the gas acceleration region includes a plurality of nozzles, the nozzles can have any of a variety of respective configurations. In the example of FIG. 3, the first nozzle 3240 includes a first nozzle outlet 3254, while the second nozzle 3264 has a second nozzle outlet 3266 that is spaced apart from the first nozzle outlet 3254. The first nozzle outlet 3254 is configured to expel a first accelerating gas flow 3112 of the reaction gas 3108 as a first fluidizing gas flow 3118, while the second nozzle outlet 3266 is configured to expel a second accelerating gas flow 3114 of the reaction gas 3108 as a second fluidizing gas flow 3120. Producing multiple fluidizing gas flows in this manner can further enhance the mixing of and/or reaction between the reaction gas 3108 with the reaction particles 3106 within the reactive bed region 3270, such as via the formation of a corresponding plurality of reaction particle spouts.

In the example of FIG. 3, the first nozzle 3240 and the second nozzle 3264 are at least substantially similar in form to one another. This is not required of all examples, however, and it additionally is within the scope of the present disclosure that the first nozzle 3240 and the second nozzle 3264 have different shapes, forms, dimensions, etc.

The dimensional considerations discussed above with reference to FIG. 2 also may be understood as applying to FIG. 3. For example, the relationship between the nozzle inlet cross-sectional area 3252 and the nozzle outlet cross-sectional area 3256 of each nozzle 3240, 3264 may be similar to the relationship between the nozzle inlet cross-sectional area 2252 and the nozzle outlet cross-sectional area 2256 of the nozzle 2240. Similarly, the sum of the nozzle inlet cross-sectional areas 3252 of the nozzles 3240, 3264 of the nozzle subassembly 3234 can be related to the moving bed region cross-sectional area 3222 of the reaction assembly housing 3210 in a similar manner as the relationship between the nozzle inlet cross-sectional area 2252 of the nozzle 2240 and the moving bed region cross-sectional area 2222 of the reaction assembly housing 2210.

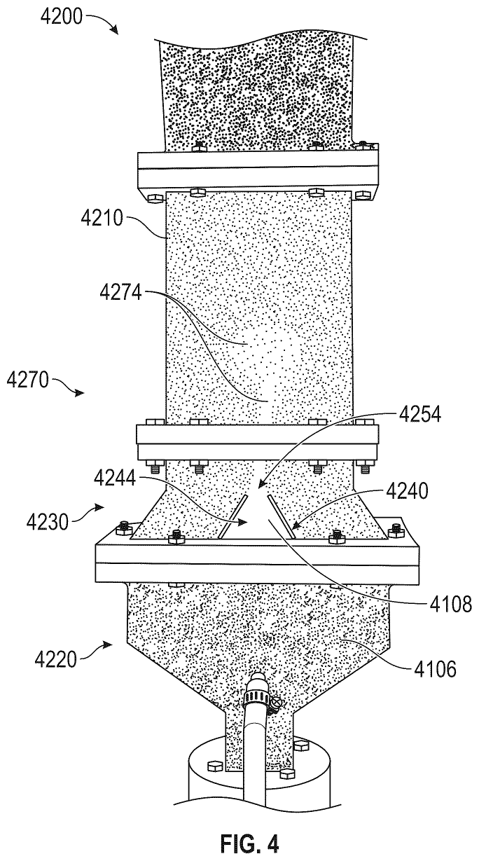

FIGS. 4-7B illustrate additional examples of reaction assemblies and/or of components thereof. Similar to FIGS. 1-3, like reference numerals are used to label like components in FIGS. 4-7B. Specifically, unless otherwise stated, all illustrated components of FIGS. 4-7B, labeled or unlabeled, can share any suitable features, characteristics, attributes, etc. with the corresponding components illustrated in FIGS. 1-3 in the manner discussed above with reference to FIGS. 1-3. Accordingly, descriptions herein of components shown in any of FIGS. 4-7B also may be understood as pertaining to corresponding components shown in any other of FIGS. 4-7B and/or in any other figure herein, such as any of FIGS. 1-3.

FIG. 4 illustrates an example of a reaction assembly 4200 during operative use. In particular, FIG. 4 illustrates an example in which the reaction assembly housing 4210 is translucent such that the reaction particles 4106 are visible through the reaction assembly housing 4210. In this manner, it may be seen that the nozzle interior region 4244 of the nozzle 4240 is substantially free of reaction particles 4106, while the reaction gas 4108 expelled from the nozzle 4240 forms particle spouts 4274 in the form of a series of bubbles within the reactive bed region 4270.

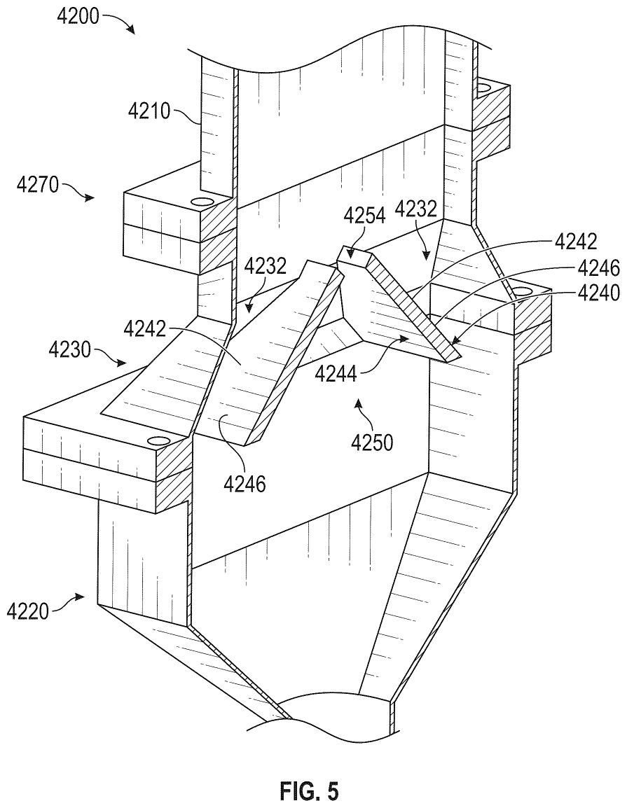

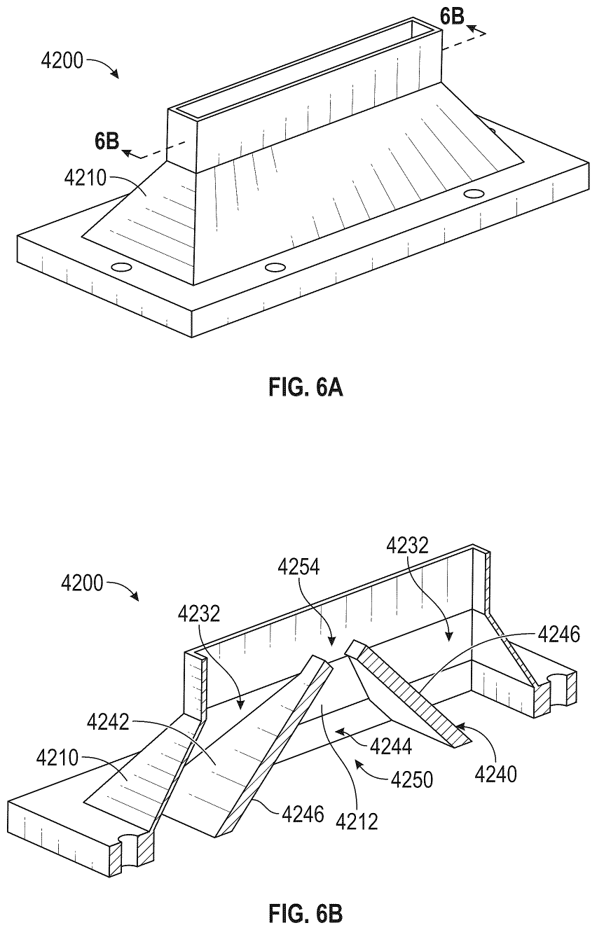

FIG. 5 is a cross-sectional perspective view of the reaction assembly 4200 of FIG. 4, while FIGS. 6A-6B illustrate additional views of a portion of the reaction assembly 4200 of FIGS. 4-5. In particular, FIGS. 6A-6B correspond to the gas acceleration region 4230 and a portion of the reactive bed region 4270 as shown in FIG. 5, with FIG. 6B representing a cross-sectional view of the reaction assembly 4200 as viewed along the line 6B-6B in FIG. 6A.

As shown in FIGS. 5-6B, the nozzle 4240 is formed by a pair of nozzle plates 4246 extending between opposed flat faces of the interior surface 4212 of the reaction assembly housing 4210 (one of which is visible in the cross-sectional views of FIGS. 5 and 6B). Accordingly, in this example, the reaction assembly 4200 includes a pair of downcomer regions 4232, each formed between a respective nozzle plate 4246 and the reaction assembly housing 4210.

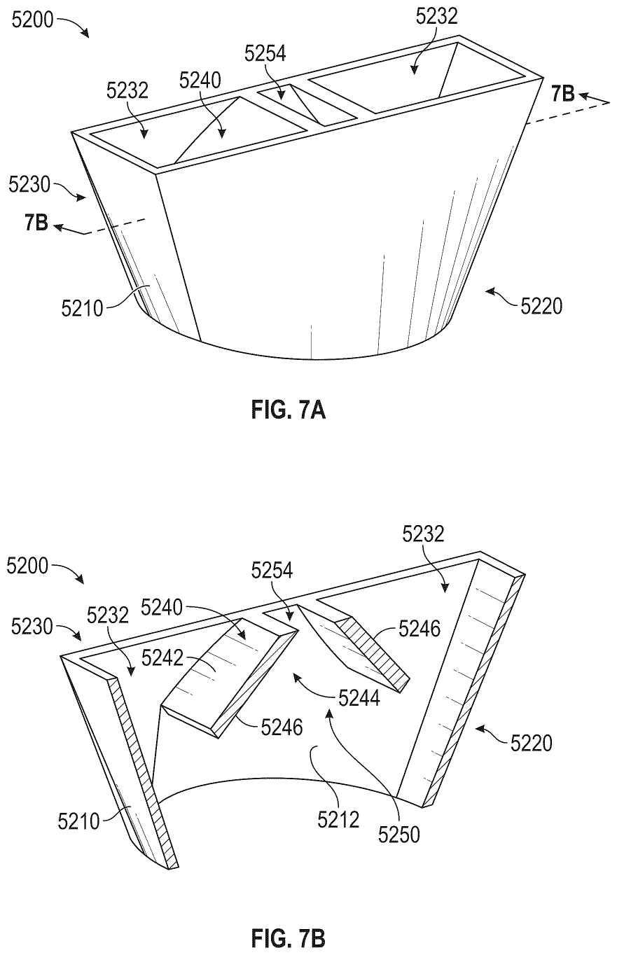

FIGS. 7A-7B illustrates another example of a portion of a reaction assembly 5200, which in this example corresponds to the gas acceleration region 5230 and a portion of the moving bed region 5220. FIG. 7B represents a cross-sectional view of the reaction assembly 5200 as viewed along the line 7B-7B in FIG. 7A. In this example, the nozzle 5240 is formed by a pair of nozzle plates 5246 extending between opposed curved faces of the interior surface 5212 of the reaction assembly housing 5210 (one of which is visible in the cross-sectional view of FIG. 7B). Accordingly, in this example, the reaction assembly 5200 includes a pair of downcomer regions 5232, each formed between a respective nozzle plate 5246 and the reaction assembly housing 5210.

Additionally, in this example, and in contrast with the example of FIGS. 4-6B, the portions of the reaction assembly housing 5210 facing the nozzle plates 5246 are tapered toward the nozzle plates 5246 along the downstream direction such that each downcomer region 5232 similarly tapers along the downstream direction. Such a configuration can, for example, yield a constriction of the downcomer regions 5232 that regulates a rate at which the reaction particles flow through and/or out of the downcomer regions 5232. In particular, in some examples, regulating the rate at which the reaction particles flow through the downcomer regions 5232, together with regulating the velocity of the fluidizing gas flow out of the nozzle outlet 5254, can facilitate generating a more uniform residence time distribution of the reaction particles within the reactive bed region.

Moreover, in the example of FIGS. 7A-7B, the reaction assembly housing 5210 has a rectangular cross-section at the upstream end of the gas acceleration region 5230 and has a circular cross-section at the downstream end of the moving bed region 5220. Accordingly, the portion of the reaction assembly housing 5210 shown in FIGS. 7A-7B can be used in a reactor system in which the reaction assembly housing 5210 transitions from a rectangular cross-section within the reactive bed region to a circular cross-sectional within and/or downstream of the moving bed region.

FIG. 8 illustrates a relationship between the particle size dₚ (e.g., the characteristic particle diameters of the reaction particles 1106) and the superficial gas velocity u_{g} of the reaction gas 1008 in each of three different gas-particle regimes. In particular, with reference to FIG. 1, the packed-moving bed regime shown in FIG. 8 may be understood as characterizing the gas-particle dynamics within the moving bed region 1220 (and/or within each downcomer region 1232), while the fluidized bed regime and/or the spouted-fluidized bed regime shown in FIG. 8 may be understood as characterizing the gas-particle dynamics within the reactive bed region 1270. In particular, the spouted-fluidized bed regime shown in FIG. 8 may be understood as characterizing the gas-particle dynamics within a spouted bed region. The fluidized bed regime illustrated in FIG. 8 may be understood as encompassing the spouted-fluidized bed regime. In this manner, FIG. 8 may be described as representing a gas-particle regime map. In particular, the gas-particle regime map of FIG. 8 corresponds to examples in which the particle density of the reaction particles is 1500 kg/m³, the characteristic particle diameter of the reaction particles is 2 mm, and the reaction gas is air at 25° C.

In FIG. 8, the dashed line separating the packed-moving bed regime and the fluidized bed regime may be described as representing the particle size-dependent minimum fluidizing gas velocity u_{mf}. Specifically, the minimum fluidizing gas velocity corresponds to the minimum gas velocity at which the gas will produce fluidizing of the particles.

Similarly, the solid line representing the boundary of the spouted-fluidized bed regime may be described as representing the particle size-dependent minimum spouting gas velocity ums. Specifically, the minimum spouting gas velocity corresponds to the minimum gas velocity at which the gas will produce spouting of the particles.

In this manner, for a given particle size dₚ characterizing the reaction particles 1106, FIG. 8 may be understood as representing preferable ranges of the superficial gas velocity dₚ of the reaction gas 1108 within each region. In particular, and as discussed above, it generally is desirable to maintain the superficial gas velocity of the reaction gas 1108 within the moving bed region 1220 below the minimum fluidizing gas velocity u_{mf} and to maintain the superficial gas velocity of the reaction gas 1108 exiting the nozzle 1240 above the minimum fluidizing gas velocity u_{mf} and/or above the minimum spouting gas velocity ums.

FIG. 9 illustrates the dependence of an expected gas velocity u of the reaction gas as a function of the volumetric flow rate vg of the reaction gas into the moving bed region. In particular, FIG. 9 represents examples in which a ratio of the nozzle outlet cross-sectional area to the moving bed region cross-sectional area is 0.01. For a given input volumetric flow rate vg of the reaction gas into the moving bed region, FIG. 9 represents the expected gas velocity at the bottom of the moving bed region (thin solid black line) and expected gas velocities of the fluidizing gas flow exiting the nozzle outlet for various nozzle geometries (dashed lines). Specifically, the dashed lines labeled with “ratio 0.5,” “ratio 0.7,” and “ratio 0.9” correspond to respective values of the diversion ratio discussed above. FIG. 9 also shows the minimum fluidizing gas velocity u_{mf} (longer broken lines) and the minimum spouting gas velocity ums (solid line), which depend upon the reaction particle and reaction gas characteristics and are independent of the input volumetric flow rate.

As shown in FIG. 9, the expected gas velocity at the bottom of the moving bed region remains below the minimum fluidizing gas velocity u_{mf} throughout the range of input volumetric flow rates considered in FIG. 9. As further shown in FIG. 9, however, the expected gas velocity at the nozzle outlet exceeds the minimum fluidizing gas velocity u_{mf} and/or the minimum spouting gas velocity ums only for certain combinations of the input volumetric flow rate and the diversion ratio characterizing the nozzle. In this manner, FIG. 9 may be understood as representing the relationship between the nozzle geometry and gas-particle flow dynamics at the nozzle outlet, such as to inform a selection of the input volumetric flow rate and/or of the diversion ratio to yield fluidizing and/or spouting in the reactive bed region.

Similar to FIG. 8, FIG. 9 corresponds to examples in which the particle density of the reaction particles is 1500 kg/m³, the characteristic particle diameter of the reaction particles is 2 mm, and the reaction gas is air at 25° C. Additionally, with reference to FIG. 2, FIG. 9 corresponds to an example in which the moving bed region cross-sectional area 2222 is 0.0025 m² and in which the reactive bed region cross-sectional area 2272 is 0.0006 m².

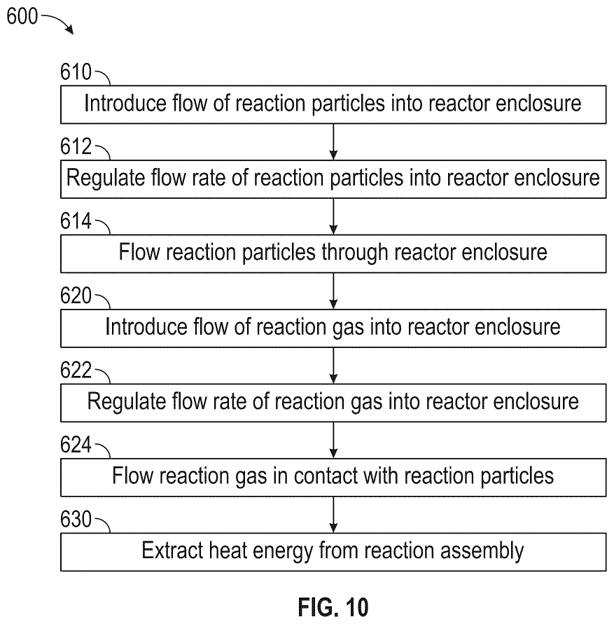

FIG. 10 is a flow chart depicting examples of a method 600 of operating a reactor system and/or a reaction assembly according to the present disclosure (e.g., the reactor system 1100, the reaction assembly 1200, the reaction assembly 2200, the reaction assembly 3200, the reaction assembly 4200, and/or the reaction assembly 5200). In the following discussion, various components are described in the context of the method 600 with terms that correspond to components illustrated in FIGS. 1-7B and discussed above. Such components described herein with reference to the method 600 thus may be understood as corresponding to and/or as representing the similarly named components described above with reference to FIGS. 1-7B.

As shown in FIG. 10, the method 600 includes introducing, at 610, a flow of reaction particles into a reactor enclosure of a reactor system and flowing, at 614, the reaction particles through the reactor enclosure in a downstream direction. The method 600 additionally includes introducing, at 620, a flow of a reaction gas into the reactor enclosure and flowing, at 624, the reaction gas in contact with the reaction particles within a reaction assembly of the reactor system. The introducing the flow of the reaction gas at 620 is performed such that the reaction gas flows through the reactor enclosure in an upstream direction that is opposite to the downstream direction. The flowing the reaction gas at 624 is performed such that the reaction gas interacts with the reaction particles to produce a moving bed region, a gas acceleration region, and a reactive bed region of the reaction assembly as described herein.

In the moving bed region, the reaction gas flows in contact with the reaction particles and flows with a superficial velocity that is lower than a fluidizing gas velocity corresponding to the reaction particles.

In the gas acceleration region, a first portion of the flow of reaction gas is accelerated to produce a fluidizing gas flow with a superficial velocity that is greater than a fluidizing gas velocity corresponding to the reaction particles. Additionally, in the gas acceleration region, the reaction particles flow in the downstream direction in contact with a second portion of the flow of reaction gas. The first portion of the flow of reaction gas can include and/or be the accelerating gas flow 1112 of FIG. 1, and/or the second portion of the flow of reaction gas can include and/or be the downcomer gas flows 1116 of FIG. 1.

In the reactive bed region, the fluidizing gas flow causes fluidizing of the reaction particles to facilitate a chemical reaction between the reaction gas and the reaction particles. In some examples, the fluidizing gas flow additionally causes spouting of the reaction particles in the reactive bed region.

In some examples, the flowing the reaction particles at 614 includes flowing such that the reaction particles flow from the reactive bed region to the moving bed region only via the gas acceleration region.

In some examples, the introducing the flow of reaction particles at 610 includes introducing the reaction particles via a passive feed mechanism, such as a hopper. Additionally or alternatively, the introducing the flow of reaction particles at 610 can include regulating, at 612, a flow rate of the reaction particles into the reactor enclosure. In such examples, the regulating the flow rate at 612 can be performed in any suitable manner, such as by introducing the reaction particles to the reactor enclosure via an active feed mechanism. As a more specific example, the active feed mechanism can include and/or be a controlled gate, and the regulating the flow rate at 612 can include regulating a frequency with which the gate is opened to permit reaction particles to flow into the reactor enclosure. Additionally or alternatively, the active feed mechanism can include and/or be a pulsed-gas particle flow controller, and the regulating the flow rate at 612 can include regulating a frequency of a pulsed gas flow that conveys the reaction particles toward and/or into the reactor enclosure.

The introducing the flow of the reaction gas at 620 can be performed in any suitable manner. For example, the introducing the flow of the reaction gas at 620 can include flowing the reaction gas through a sparger disposed within the reactor enclosure and/or flowing the reaction gas through a perforated plate disposed within the reactor enclosure. In some examples, the introducing the flow of the reaction gas at 620 includes regulating, at 622, a flow rate of the reaction gas into the reactor enclosure, such as with a gas regulator.

As discussed above, the flowing the reaction gas in contact with the reaction particles at 624 can include initiating, sustaining, and/or facilitating a chemical reaction between the reaction gas and the reaction particles. In particular, such a chemical reaction can be an exothermic chemical reaction that produces usable heat energy. Accordingly, in some examples, and as shown in FIG. 10, the method 600 additionally includes extracting, at 630, the heat energy from the reaction assembly. The extracting the heat energy at 630 can be performed in any suitable manner, such as by conveying heat energy from the reactive bed region of the reaction assembly to a process fluid via a heat exchanger.

### Additional Examples of the Disclosed Technology

Having described and illustrated the principles of the disclosed technology with reference to the illustrated examples, it will be recognized that the illustrated examples can be modified in arrangement and detail without departing from such principles. For instance, elements of examples performed in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.
Example 1. A reaction assembly for facilitating a chemical reaction between a reaction gas and reaction particles within a reactor system, the reaction assembly comprising: a reaction assembly housing configured to support a flow of the reaction gas in an upstream direction and a flow of the reaction particles in a downstream direction opposite to the upstream direction; a moving bed region; a gas acceleration region upstream of the moving bed region; and a spouted bed region upstream of the gas acceleration region, wherein the reaction assembly is configured such that, during operative use of the reaction assembly: the reaction gas flows in contact with the reaction particles in the moving bed region; a portion of the flow of the reaction gas is accelerated within the gas acceleration region to produce a spouting gas flow; and the spouting gas flow causes spouting of the reaction particles within the spouted bed region to facilitate the chemical reaction between the reaction gas and the reaction particles within the spouted bed region.
Example 2. The reaction assembly of any example herein, particularly example 1, wherein the reaction assembly is configured such that, during operative use of the reaction assembly, the reaction particles flow from the spouted bed region to the moving bed region only via the gas acceleration region.
Example 3. The reaction assembly of any example herein, particularly any one of examples 1-2, wherein the reaction assembly is configured such that, during operative use of the reaction assembly: (i) the reaction gas has a superficial velocity within the moving bed region that is lower than a fluidizing gas velocity corresponding to the reaction particles; and (ii) the superficial velocity of the spouting gas flow is greater than a spouting gas velocity corresponding to the reaction particles.
Example 4. The reaction assembly of any example herein, particularly any one of examples 1-3, wherein the chemical reaction is an exothermic reaction, optionally an oxidation reaction.
Example 5. The reaction assembly of any example herein, particularly any one of examples 1-4, wherein the reaction particles comprise metal oxide particles, optionally particles comprising one or both of magnesium oxide and manganese oxide.
Example 6. The reaction assembly of any example herein, particularly any one of examples 1-5, wherein the reaction particles have an average characteristic particle diameter that is one or more of at least 0.1 millimeters (mm), at least 0.5 mm, at least 1 mm, at least 5 mm, at least 10 mm, at least 15 mm, at most 20 mm, at most 12 mm, at most 7 mm, at most 2 mm, at most 0.7 mm, at most 0.2 mm, 0.1-1 mm, 0.5-5 mm, 1-10 mm, 5-15 mm, or 10-20 mm.
Example 7. The reaction assembly of any example herein, particularly any one of examples 1-6, wherein the reaction particles have an average particle density that is one or more of at least 500 kilograms per cubic meter (kg/m³), at least 1000 kg/m³, at least 1500 kg/m³, at least 2000 kg/m³, at most 2500 kg/m³, at most 1700 kg/m³, at most 1200 kg/m³, at most 700 kg/m³, 500-1500 kg/m³, 1000-2000 kg/m³, or 1500-2500 kg/m³.
Example 8. The reaction assembly of any example herein, particularly any one of examples 1-7, wherein the reaction particles comprise spherical particles.
Example 9. The reaction assembly of any example herein, particularly any one of examples 1-8, wherein the reaction particles comprise non-spherical particles.
Example 10. The reaction assembly of any example herein, particularly any one of examples 1-9, wherein the reaction gas comprises oxygen.
Example 11. The reaction assembly of any example herein, particularly any one of examples 1-10, wherein the reaction gas comprises air.
Example 12. The reaction assembly of any example herein, particularly any one of examples 1-11, wherein the reaction assembly is configured such that, during operative use of the reaction assembly, a temperature of one or both of the reaction particles and the reaction gas within the spouted bed region is at least substantially uniform.
Example 13. The reaction assembly of any example herein, particularly any one of examples 1-12, wherein the reaction assembly is configured such that, during operative use of the reaction assembly, a temperature of one or both of the reaction particles and the reaction gas within the moving bed region decreases along the downstream direction.
Example 14. The reaction assembly of any example herein, particularly any one of examples 1-13, wherein the gas acceleration region comprises: a nozzle configured to accelerate the reaction gas; and one or more downcomer regions defined between the nozzle and the reaction assembly housing.
Example 15. The reaction assembly of any example herein, particularly example 14, wherein the reaction assembly is configured such that, during operative use of the reaction assembly, the reaction particles flow from the spouted bed region to the moving bed region only via the one or more downcomer regions.
Example 16. The reaction assembly of any example herein, particularly any one of examples 14-15, wherein the nozzle is configured to accelerate the reaction gas such that the reaction gas exits the nozzle with sufficient velocity to cause spouting of the reaction particles within the spouted bed region.
Example 17. The reaction assembly of any example herein, particularly any one of examples 14-16, wherein the nozzle defines a nozzle interior region, and wherein the reaction assembly is configured such that the nozzle interior region is at least partially free of reaction particles during operative use of the reaction assembly.
Example 18. The reaction assembly of any example herein, particularly any one of examples 14-17, wherein the nozzle extends between and comprises a nozzle inlet configured to receive the reaction gas and a nozzle outlet configured to expel the reaction gas, wherein the nozzle inlet has a nozzle inlet cross-sectional area, as measured in a plane extending perpendicular to the upstream direction, and wherein the nozzle outlet has a nozzle outlet cross-sectional area, as measured in a plane extending perpendicular to the upstream direction, that is smaller than the nozzle inlet cross-sectional area.
Example 19. The reaction assembly of any example herein, particularly example 18, wherein a ratio of the nozzle inlet cross-sectional area to the nozzle outlet cross-sectional area is one or more of at least 20:1, at least 40:1 at least 60:1, at least 80:1, at least 100:1, at least 120:1 at most 150:1, at most 110:1, at most 90:1, at most 70:1, at most 50:1, at most 30:1, 20:1-60:1, 40:1-80:1, 60:1-100:1, 80:1-120:1, or 100:1-150:1.
Example 20. The reaction assembly of any example herein, particularly any one of examples 18-19, wherein the nozzle inlet has a nozzle inlet cross-sectional area, as measured in a plane extending perpendicular to the upstream direction, wherein the reaction assembly housing as a moving bed region cross-sectional area, as measured in the plane in which the nozzle inlet cross-sectional area is measured, and wherein a ratio of the nozzle inlet cross-sectional area to the moving bed region cross-sectional area is one or more of at least 0.3:1, at least 0.5:1, at least 0.7:1, at most 0.8:1, at most 0.6:1, at most 0.4:1, 0.3:1-0.7:1, or 0.5:1-0.8:1.
Example 21. The reaction assembly of any example herein, particularly any one of examples 18-20, wherein the nozzle has a nozzle height, as measured between the nozzle inlet and the nozzle outlet along the downstream direction, wherein the nozzle has a nozzle maximum width, as measured along a direction perpendicular to the downstream direction, and wherein a ratio of the nozzle height to the nozzle maximum width is one or more of at least 0.2:1, at least 0.25:1, at least 0.33:1, at least 0.5:1, 1:1, at least 2:1, at least 3:1 at least 4:1, at most 5:1, at most 4.5:1, at most 3.5:1, at most 2.5:1, at most 1.5:1, at most 0.66:1, at most 0.4:1, at most 0.29:1, at most 0.22:1, 0.2:1-0.33:1, 0.25:1-0.5:1, 0.33:1-1:1, 0.5:1-2:1, 1:1-3:1, 2:1-4:1, or 3:1-5:1.
Example 22. The reaction assembly of any example herein, particularly any one of examples 18-21, wherein the nozzle outlet is a first nozzle outlet, and wherein the nozzle further comprises a second nozzle outlet spaced apart from the first nozzle outlet.
Example 23. The reaction assembly of any example herein, particularly any one of examples 14-22, wherein the nozzle is supported by the reaction assembly housing.
Example 24. The reaction assembly of any example herein, particularly any one of examples 14-23, wherein the nozzle comprises one or more nozzle plates that are fixedly coupled to an interior surface of the reaction assembly housing.
Example 25. The reaction assembly of any example herein, particularly any one of examples 14-24, further comprising one or more nozzle supports extending between the nozzle and the reaction assembly housing to support the nozzle within the gas acceleration region.
Example 26. The reaction assembly of any example herein, particularly any one of examples 14-25, wherein the nozzle is a first nozzle, and wherein the gas acceleration region further comprises a second nozzle configured to accelerate the reaction gas.
Example 27. The reaction assembly of any example herein, particularly example 26, further comprising a nozzle subassembly that comprises the first nozzle and the second nozzle.
Example 28. The reaction assembly of any example herein, particularly any one of examples 14-27, wherein each downcomer region is defined by one or both of: (i) a nozzle outer surface of the nozzle; and (ii) an interior surface of the reaction assembly housing.
Example 29. The reaction assembly of any example herein, particularly any one of examples 14-28, wherein each downcomer region is configured such that, during operative use of the reaction assembly, a downcomer gas flow of the reaction gas flows through the downcomer region in the upstream direction with a downcomer gas flow velocity that is sufficiently small to allow the reaction particles to flow through the downcomer region in the downstream direction.
Example 30. The reaction assembly of any example herein, particularly any one of examples 1-29, wherein the reaction assembly housing is tapered within the gas acceleration region.
Example 31. The reaction assembly of any example herein, particularly any one of examples 1-30, wherein the reaction assembly housing has a spouted bed region cross-sectional area within the spouted bed region, and wherein the reaction assembly housing has a moving bed region cross-sectional area within the moving bed region that is greater than the spouted bed region cross-sectional area.
Example 32. The reaction assembly of any example herein, particularly example 31, wherein each of the spouted bed region cross-sectional area and the moving bed region cross-sectional area is measured in a respective plane extending perpendicular to the downstream direction.
Example 33. A reactor system comprising: a reactor enclosure; a reaction particle inlet configured to introduce reaction particles into the reactor enclosure, wherein the reactor system is configured such that the reaction particles flow through the reactor enclosure in a downstream direction; a reaction gas inlet configured to introduce a flow of a reaction gas into the reactor enclosure, wherein the reactor system is configured such that the reaction gas flows through the reactor enclosure in an upstream direction opposite to the downstream direction; and the reaction assembly of any example herein, particularly any one of examples 1-32 disposed between the reaction particle inlet and the reaction gas inlet.
Example 34. The reactor system of any example herein, particularly example 33, further comprising a heat exchanger configured to bring a process fluid into thermal contact with the reaction assembly.
Example 35. The reactor system of any example herein, particularly example 34, wherein the heat exchanger is configured to convey heat energy from the reaction assembly housing to the process fluid.
Example 36. The reactor system of any example herein, particularly any one of examples 33-35, wherein the reactor enclosure comprises at least a portion of the reaction assembly housing.
Example 37. The reactor system of any example herein, particularly any one of examples 33-36, wherein the reaction particle inlet comprises an orifice through which the reaction particles are introduced into the reactor enclosure.
Example 38. The reactor system of any example herein, particularly any one of examples 33-37, further comprising a particle feed subassembly configured to introduce the reaction particles to the reactor enclosure via the reaction particle inlet.
Example 39. The reactor system of any example herein, particularly example 38, wherein the particle feed subassembly comprises the reaction particle inlet.
Example 40. The reactor system of any example herein, particularly any one of examples 38-39, wherein the particle feed subassembly comprises a hopper configured to direct the reaction particles into the reactor enclosure, optionally via an orifice.
Example 41. The reactor system of any example herein, particularly any one of examples 38-40, wherein the particle feed subassembly comprises an active feed mechanism configured to regulate a feed rate at which the reaction particles are introduced into the reactor enclosure.
Example 42. The reactor system of any example herein, particularly example 41, wherein the active feed mechanism comprises a controlled gate configured to selectively opened and closed to permit and restrict ingress of the reaction particles into the reactor enclosure.
Example 43. The reactor system of any example herein, particularly any one of examples 41-42, wherein the active feed mechanism comprises a pulsed-gas particle flow controller configured to at least partially control a rate at which the reaction particles flow toward and/or into the reactor enclosure using a pulsed gas flow.
Example 44. The reactor system of any example herein, particularly any one of examples 33-43, further comprising a reaction gas distributor configured to introduce the reaction gas into the reactor enclosure via the reaction gas inlet.
Example 45. The reactor system of any example herein, particularly example 44, wherein the reaction gas distributor is configured to regulate a flow rate at which the reaction gas is introduced into the reactor enclosures.
Example 46. The reactor system of any example herein, particularly any one of examples 44-45, wherein the reaction gas distributor comprises a sparger disposed within the reactor enclosure, wherein the sparger comprises the reaction gas inlet, and wherein the sparger is configured to permit the reaction particles to flow past the sparger in the downstream direction.
Example 47. The reactor system of any example herein, particularly any one of examples 44-46, wherein the reaction gas distributor comprises a perforated plate disposed within the reactor enclosure.
Example 48. The reactor system of any example herein, particularly any one of examples 33-47, further comprising a reaction gas outlet positioned upstream of the spouted bed region and configured to exhaust the reaction gas from the reactor enclosure.
Example 49. The reactor system of any example herein, particularly any one of examples 33-48, further comprising a particle disposal subassembly disposed downstream of the moving bed region and configured to remove the reaction particles from the reactor enclosure.
Example 50. The reactor system of any example herein, particularly example 49, wherein the particle disposal subassembly comprises a waste particle conduit configured to convey the reaction particles away from the reactor enclosure.
Example 51. The reactor system of any example herein, particularly example 50, wherein the particle disposal subassembly comprises a pulsed-gas particle conveyor configured to convey the reaction particles through the waste particle conduit with a pulsed gas flow.
Example 52. The reactor system of any example herein, particularly any one of examples 49-51, wherein the particle disposal subassembly comprises a waste particle receptacle configured to receive and store the reaction particles removed from the reactor enclosure.
Example 53. The reactor system of any example herein, particularly any one of examples 49-52, wherein the particle disposal subassembly is configured to restrict the reaction gas from exiting the reactor enclosure via the particle disposal subassembly.
Example 54. A method of operating a reactor system, the method comprising: introducing a flow of reaction particles into a reactor enclosure of the reactor system; flowing the reaction particles through the reactor enclosure in a downstream direction; introducing a flow of a reaction gas into the reactor enclosure such the reaction gas flows through the reactor enclosure in an upstream direction opposite to the downstream direction; and flowing the reaction gas in contact with the reaction particles within a reaction assembly of the reactor system such that the reaction gas interacts with the reaction particles to produce: a moving bed region of the reaction assembly, in which the reaction gas flows in contact with the reaction particles and flows with a superficial velocity that is lower than a fluidizing gas velocity corresponding to the reaction particles; a gas acceleration region of the reaction assembly, in which a first portion of the flow of reaction gas is accelerated to produce a spouting gas flow with a superficial velocity that is greater than a spouting gas velocity corresponding to the reaction particles and in which the reaction particles flow in the downstream direction in contact with a second portion of the flow of reaction gas; and a spouted bed region of the reaction assembly, in which the spouting gas flow causes spouting of the reaction particles to facilitate a chemical reaction between the reaction gas and the reaction particles.
Example 55. The method of any example herein, particularly example 54, wherein the flowing the reaction particles through the reactor enclosure comprises flowing such that the reaction particles flow from the spouted bed region to the moving bed region only via the gas acceleration region.
Example 56. The method of any example herein, particularly any one of examples 54-55, wherein the introducing the flow of reaction particles comprises introducing the reaction particles via a passive feed mechanism.
Example 57. The method of any example herein, particularly example 56, wherein the passive feed mechanism comprises a hopper.
Example 58. The method of any example herein, particularly any one of examples 54-57, wherein the introducing the flow of reaction particles comprises regulating a flow rate of the reaction particles into the reactor enclosure.
Example 59. The method of any example herein, particularly example 58, wherein the regulating the flow rate of the reaction particles comprises introducing the reaction particles via an active feed mechanism.
Example 60. The method of any example herein, particularly example 59, wherein the active feed mechanism comprises a controlled gate, and wherein the regulating the flow rate of the reaction particles comprises regulating a frequency with which the gate is opened to permit reaction particles to flow into the reactor enclosure.
Example 61. The method of any example herein, particularly any one of examples 59-60, wherein the active feed mechanism comprises a pulsed-gas particle flow controller, and wherein the regulating the flow rate of the reaction particles comprises regulating a frequency of a pulsed gas flow that conveys the reaction particles toward and/or into the reactor enclosure.
Example 62. The method of any example herein, particularly any one of examples 54-61, wherein the introducing the flow of the reaction gas comprises regulating a flow rate of the reaction gas into the reactor enclosure.
Example 63. The method of any example herein, particularly any one of examples 54-62, wherein the introducing the flow of the reaction gas comprises flowing the reaction gas through a sparger disposed within the reactor enclosure.
Example 64. The method of any example herein, particularly any one of examples 54-63, wherein the introducing the flow of the reaction gas comprises flowing the reaction gas through a perforated plate disposed within the reactor enclosure.
Example 65. The method of any example herein, particularly any one of examples 54-64, wherein the chemical reaction comprises an exothermic chemical reaction, and wherein the method comprises extracting heat energy from the reaction assembly.
Example 66. The method of any example herein, particularly example 65, wherein the extracting the heat energy comprises conveying heat energy from the spouted bed region of the reaction assembly to a process fluid via a heat exchanger.
Example 67. A reaction assembly for facilitating a chemical reaction between a reaction gas and reaction particles within a reactor system, the reaction assembly comprising: a reaction assembly housing configured to support a flow of the reaction gas in an upstream direction and a flow of the reaction particles in a downstream direction opposite to the upstream direction; a moving bed region; a gas acceleration region upstream of the moving bed region; and a reactive bed region upstream of the gas acceleration region, wherein the reaction assembly is configured such that, during operative use of the reaction assembly: the reaction gas flows in contact with the reaction particles in the moving bed region; a portion of the flow of the reaction gas is accelerated within the gas acceleration region to produce a fluidizing gas flow; and the fluidizing gas flow causes fluidizing of the reaction particles within the reactive bed region to facilitate the chemical reaction between the reaction gas and the reaction particles within the reactive bed region.
Example 68. The reaction assembly of any example herein, particularly example 67, further comprising the subject matter of any other example herein, particularly any one of examples 1-32.
Example 69. The reaction assembly of any example herein, particularly any one of examples 67-68, wherein the reactive bed region comprises a spouted bed region, and wherein the fluidizing gas flow comprises a spouting gas flow that causes spouting of the reaction particles within the spouted bed region to facilitate the chemical reaction between the reaction gas and the reaction particles within the spouted bed region.
Example 70. The reaction assembly of any example herein, particularly any one of examples 67-69, wherein the reaction assembly is configured such that, during operative use of the reaction assembly, the reaction particles flow from the reactive bed region to the moving bed region only via the gas acceleration region.
Example 71. The reaction assembly of any example herein, particularly any one of examples 67-70, wherein the reaction assembly is configured such that, during operative use of the reaction assembly: (i) the reaction gas has a superficial velocity within the moving bed region that is lower than a fluidizing gas velocity corresponding to the reaction particles; and (ii) the superficial velocity of the fluidizing gas flow is greater than the fluidizing gas velocity corresponding to the reaction particles.
Example 72. The reaction assembly of any example herein, particularly example 71, wherein the superficial velocity of the fluidizing gas flow is greater than a spouting gas velocity corresponding to the reaction particles.
Example 73. The reaction assembly of any example herein, particularly any one of examples 67-72, wherein the chemical reaction is an exothermic reaction, optionally an oxidation reaction.
Example 74. The reaction assembly of any example herein, particularly any one of examples 67-73, wherein the reaction particles comprise metal oxide particles, optionally particles comprising one or both of magnesium oxide and manganese oxide.
Example 75. The reaction assembly of any example herein, particularly any one of examples 67-74, wherein the reaction particles have an average characteristic particle diameter that is one or more of at least 0.1 millimeters (mm), at least 0.5 mm, at least 1 mm, at least 5 mm, at least 10 mm, at least 15 mm, at most 20 mm, at most 12 mm, at most 7 mm, at most 2 mm, at most 0.7 mm, at most 0.2 mm, 0.1-1 mm, 0.5-5 mm, 1-10 mm, 5-15 mm, or 10-20 mm.
Example 76. The reaction assembly of any example herein, particularly any one of examples 67-75, wherein the reaction particles have an average particle density that is one or more of at least 500 kilograms per cubic meter (kg/m³), at least 1000 kg/m³, at least 1500 kg/m³, at least 2000 kg/m³, at most 2500 kg/m³, at most 1700 kg/m³, at most 1200 kg/m³, at most 700 kg/m³, 500-1500 kg/m³, 1000-2000 kg/m³, or 1500-2500 kg/m³.
Example 77. The reaction assembly of any example herein, particularly any one of examples 67-76, wherein the reaction particles comprise spherical particles.
Example 78. The reaction assembly of any example herein, particularly any one of examples 67-77, wherein the reaction particles comprise non-spherical particles.
Example 79. The reaction assembly of any example herein, particularly any one of examples 67-78, wherein the reaction gas comprises oxygen.
Example 80. The reaction assembly of any example herein, particularly any one of examples 67-79, wherein the reaction gas comprises air.
Example 81. The reaction assembly of any example herein, particularly any one of examples 67-80, wherein the reaction assembly is configured such that, during operative use of the reaction assembly, a temperature of one or both of the reaction particles and the reaction gas within the reactive bed region is at least substantially uniform.
Example 82. The reaction assembly of any example herein, particularly any one of examples 67-81, wherein the reaction assembly is configured such that, during operative use of the reaction assembly, a temperature of one or both of the reaction particles and the reaction gas within the moving bed region decreases along the downstream direction.
Example 83. The reaction assembly of any example herein, particularly any one of examples 67-82, wherein the gas acceleration region comprises: a nozzle configured to accelerate the reaction gas; and one or more downcomer regions defined between the nozzle and the reaction assembly housing.
Example 84. The reaction assembly of any example herein, particularly example 83, wherein the reaction assembly is configured such that, during operative use of the reaction assembly, the reaction particles flow from the reactive bed region to the moving bed region only via the one or more downcomer regions.
Example 85. The reaction assembly of any example herein, particularly any one of examples 83-84, wherein the nozzle is configured to accelerate the reaction gas such that the reaction gas exits the nozzle with sufficient velocity to cause fluidizing of the reaction particles within the reactive bed region.
Example 86. The reaction assembly of any example herein, particularly any one of examples 83-85, wherein the nozzle defines a nozzle interior region, and wherein the reaction assembly is configured such that the nozzle interior region is at least partially free of reaction particles during operative use of the reaction assembly.
Example 87. The reaction assembly of any example herein, particularly any one of examples 83-86, wherein the nozzle extends between and comprises a nozzle inlet configured to receive the reaction gas and a nozzle outlet configured to expel the reaction gas, wherein the nozzle inlet has a nozzle inlet cross-sectional area, as measured in a plane extending perpendicular to the upstream direction, and wherein the nozzle outlet has a nozzle outlet cross-sectional area, as measured in a plane extending perpendicular to the upstream direction, that is smaller than the nozzle inlet cross-sectional area.
Example 88. The reaction assembly of any example herein, particularly example 87, wherein a ratio of the nozzle inlet cross-sectional area to the nozzle outlet cross-sectional area is one or more of at least 20:1, at least 40:1 at least 60:1, at least 80:1, at least 100:1, at least 120:1 at most 150:1, at most 110:1, at most 90:1, at most 70:1, at most 50:1, at most 30:1, 20:1-60:1, 40:1-80:1, 60:1-100:1, 80:1-120:1, or 100:1-150:1.
Example 89. The reaction assembly of any example herein, particularly any one of examples 87-88, wherein the nozzle inlet has a nozzle inlet cross-sectional area, as measured in a plane extending perpendicular to the upstream direction, wherein the reaction assembly housing as a moving bed region cross-sectional area, as measured in the plane in which the nozzle inlet cross-sectional area is measured, and wherein a ratio of the nozzle inlet cross-sectional area to the moving bed region cross-sectional area is one or more of at least 0.3:1, at least 0.5:1, at least 0.7:1, at most 0.8:1, at most 0.6:1, at most 0.4:1, 0.3:1-0.7:1, or 0.5:1-0.8:1.
Example 90. The reaction assembly of any example herein, particularly any one of examples 87-89, wherein the nozzle has a nozzle height, as measured between the nozzle inlet and the nozzle outlet along the downstream direction, wherein the nozzle has a nozzle maximum width, as measured along a direction perpendicular to the downstream direction, and wherein a ratio of the nozzle height to the nozzle maximum width is one or more of at least 0.2:1, at least 0.25:1, at least 0.33:1, at least 0.5:1, 1:1, at least 2:1, at least 3:1 at least 4:1, at most 5:1, at most 4.5:1, at most 3.5:1, at most 2.5:1, at most 1.5:1, at most 0.66:1, at most 0.4:1, at most 0.29:1, at most 0.22:1, 0.2:1-0.33:1, 0.25:1-0.5:1, 0.33:1-1:1, 0.5:1-2:1, 1:1-3:1, 2:1-4:1, or 3:1-5:1.
Example 91. The reaction assembly of any example herein, particularly any one of examples 87-90, wherein the nozzle outlet is a first nozzle outlet, and wherein the nozzle further comprises a second nozzle outlet spaced apart from the first nozzle outlet.
Example 92. The reaction assembly of any example herein, particularly any one of examples 83-91, wherein the nozzle is supported by the reaction assembly housing.
Example 93. The reaction assembly of any example herein, particularly any one of examples 83-92, wherein the nozzle comprises one or more nozzle plates that are fixedly coupled to an interior surface of the reaction assembly housing.
Example 94. The reaction assembly of any example herein, particularly any one of examples 83-93, further comprising one or more nozzle supports extending between the nozzle and the reaction assembly housing to support the nozzle within the gas acceleration region.
Example 95. The reaction assembly of any example herein, particularly any one of examples 83-94, wherein the nozzle is a first nozzle, and wherein the gas acceleration region further comprises a second nozzle configured to accelerate the reaction gas.
Example 96. The reaction assembly of any example herein, particularly example 85, further comprising a nozzle subassembly that comprises the first nozzle and the second nozzle.
Example 97. The reaction assembly of any example herein, particularly any one of examples 83-96, wherein each downcomer region is defined by one or both of: (i) a nozzle outer surface of the nozzle; and (ii) an interior surface of the reaction assembly housing.
Example 98. The reaction assembly of any example herein, particularly any one of examples 83-97, wherein each downcomer region is configured such that, during operative use of the reaction assembly, a downcomer gas flow of the reaction gas flows through the downcomer region in the upstream direction with a downcomer gas flow velocity that is sufficiently small to allow the reaction particles to flow through the downcomer region in the downstream direction.
Example 99. The reaction assembly of any example herein, particularly any one of examples 76-98, wherein the reaction assembly housing is tapered within the gas acceleration region.
Example 100. The reaction assembly of any example herein, particularly any one of examples 67-99, wherein the reaction assembly housing has a reactive bed region cross-sectional area within the reactive bed region, and wherein the reaction assembly housing has a moving bed region cross-sectional area within the moving bed region that is greater than the reactive bed region cross-sectional area.
Example 101. The reaction assembly of any example herein, particularly example 100, wherein each of the reactive bed region cross-sectional area and the moving bed region cross-sectional area is measured in a respective plane extending perpendicular to the downstream direction.
Example 102. A reactor system comprising: a reactor enclosure; a reaction particle inlet configured to introduce reaction particles into the reactor enclosure, wherein the reactor system is configured such that the reaction particles flow through the reactor enclosure in a downstream direction; a reaction gas inlet configured to introduce a flow of a reaction gas into the reactor enclosure, wherein the reactor system is configured such that the reaction gas flows through the reactor enclosure in an upstream direction opposite to the downstream direction; and the reaction assembly of any example herein, particularly any one of examples 67-101, disposed between the reaction particle inlet and the reaction gas inlet.
Example 103. The reactor system of any example herein, particularly example 102, further comprising the subject matter of any other example herein, particularly any one of examples 33-53.
Example 104. The reactor system of any example herein, particularly any one of examples 102-103, further comprising a heat exchanger configured to bring a process fluid into thermal contact with the reaction assembly.
Example 105. The reactor system of any example herein, particularly example 104, wherein the heat exchanger is configured to convey heat energy from the reaction assembly housing to the process fluid.
Example 106. The reactor system of any example herein, particularly any one of examples 102-105, wherein the reactor enclosure comprises at least a portion of the reaction assembly housing.
Example 107. The reactor system of any example herein, particularly any one of examples 102-106, wherein the reaction particle inlet comprises an orifice through which the reaction particles are introduced into the reactor enclosure.
Example 108. The reactor system of any example herein, particularly any one of examples 102-107, further comprising a particle feed subassembly configured to introduce the reaction particles to the reactor enclosure via the reaction particle inlet.
Example 109. The reactor system of any example herein, particularly example 108, wherein the particle feed subassembly comprises the reaction particle inlet.
Example 110. The reactor system of any example herein, particularly any one of examples 108-109, wherein the particle feed subassembly comprises a hopper configured to direct the reaction particles into the reactor enclosure, optionally via an orifice.
Example 111. The reactor system of any example herein, particularly any one of examples 108-110, wherein the particle feed subassembly comprises an active feed mechanism configured to regulate a feed rate at which the reaction particles are introduced into the reactor enclosure.
Example 112. The reactor system of any example herein, particularly example 111, wherein the active feed mechanism comprises a controlled gate configured to selectively opened and closed to permit and restrict ingress of the reaction particles into the reactor enclosure.
Example 113. The reactor system of any example herein, particularly any one of examples 111-112, wherein the active feed mechanism comprises a pulsed-gas particle flow controller configured to at least partially control a rate at which the reaction particles flow toward and/or into the reactor enclosure using a pulsed gas flow.
Example 114. The reactor system of any example herein, particularly any one of examples 102-113, further comprising a reaction gas distributor configured to introduce the reaction gas into the reactor enclosure via the reaction gas inlet.
Example 115. The reactor system of any example herein, particularly example 114, wherein the reaction gas distributor is configured to regulate a flow rate at which the reaction gas is introduced into the reactor enclosures.
Example 116. The reactor system of any example herein, particularly any one of examples 114-115, wherein the reaction gas distributor comprises a sparger disposed within the reactor enclosure, wherein the sparger comprises the reaction gas inlet, and wherein the sparger is configured to permit the reaction particles to flow past the sparger in the downstream direction.
Example 117. The reactor system of any example herein, particularly any one of examples 114-116, wherein the reaction gas distributor comprises a perforated plate disposed within the reactor enclosure.
Example 118. The reactor system of any example herein, particularly any one of examples 102-117, further comprising a reaction gas outlet positioned upstream of the reactive bed region and configured to exhaust the reaction gas from the reactor enclosure.
Example 119. The reactor system of any example herein, particularly any one of examples 102-118, further comprising a particle disposal subassembly disposed downstream of the moving bed region and configured to remove the reaction particles from the reactor enclosure.
Example 120. The reactor system of any example herein, particularly example 119, wherein the particle disposal subassembly comprises a waste particle conduit configured to convey the reaction particles away from the reactor enclosure.
Example 121. The reactor system of any example herein, particularly example 120, wherein the particle disposal subassembly comprises a pulsed-gas particle conveyor configured to convey the reaction particles through the waste particle conduit with a pulsed gas flow.
Example 122. The reactor system of any example herein, particularly any one of examples 119-121, wherein the particle disposal subassembly comprises a waste particle receptacle configured to receive and store the reaction particles removed from the reactor enclosure.
Example 123. The reactor system of any example herein, particularly any one of examples 119-122, wherein the particle disposal subassembly is configured to restrict the reaction gas from exiting the reactor enclosure via the particle disposal subassembly.
Example 124. A method of operating a reactor system, the method comprising: introducing a flow of reaction particles into a reactor enclosure of the reactor system; flowing the reaction particles through the reactor enclosure in a downstream direction; introducing a flow of a reaction gas into the reactor enclosure such the reaction gas flows through the reactor enclosure in an upstream direction opposite to the downstream direction; and flowing the reaction gas in contact with the reaction particles within a reaction assembly of the reactor system such that the reaction gas interacts with the reaction particles to produce: a moving bed region of the reaction assembly, in which the reaction gas flows in contact with the reaction particles and flows with a superficial velocity that is lower than a fluidizing gas velocity corresponding to the reaction particles; a gas acceleration region of the reaction assembly, in which a first portion of the flow of reaction gas is accelerated to produce a fluidizing gas flow with a superficial velocity that is greater than the fluidizing gas velocity corresponding to the reaction particles and in which the reaction particles flow in the downstream direction in contact with a second portion of the flow of reaction gas; and a reactive bed region of the reaction assembly, in which the fluidizing gas flow causes fluidizing of the reaction particles to facilitate a chemical reaction between the reaction gas and the reaction particles.
Example 125. The method of any example herein, particularly example 124, further comprising the subject matter of any other example herein, particularly any one of examples 55-66.
Example 126. The method of any example herein, particularly any one of examples 124-125, wherein the fluidizing gas flow comprises a spouting gas flow with a superficial velocity that is greater than a spouting gas velocity corresponding to the reaction particles, and wherein the reactive bed region comprises a spouted bed region in which the spouting gas flow causes spouting of the reaction particles to facilitate the chemical reaction between the reaction gas and the reaction particles.
Example 127. The method of any example herein, particularly any one of examples 124-126, wherein the flowing the reaction particles through the reactor enclosure comprises flowing such that the reaction particles flow from the reactive bed region to the moving bed region only via the gas acceleration region.
Example 128. The method of any example herein, particularly any one of examples 124-127, wherein the introducing the flow of reaction particles comprises introducing the reaction particles via a passive feed mechanism.
Example 129. The method of any example herein, particularly example 128, wherein the passive feed mechanism comprises a hopper.
Example 130. The method of any example herein, particularly any one of examples 124-129, wherein the introducing the flow of reaction particles comprises regulating a flow rate of the reaction particles into the reactor enclosure.
Example 131. The method of any example herein, particularly example 130, wherein the regulating the flow rate of the reaction particles comprises introducing the reaction particles via an active feed mechanism.
Example 132. The method of any example herein, particularly example 131, wherein the active feed mechanism comprises a controlled gate, and wherein the regulating the flow rate of the reaction particles comprises regulating a frequency with which the gate is opened to permit reaction particles to flow into the reactor enclosure.
Example 133. The method of any example herein, particularly any one of examples 131-132, wherein the active feed mechanism comprises a pulsed-gas particle flow controller, and wherein the regulating the flow rate of the reaction particles comprises regulating a frequency of a pulsed gas flow that conveys the reaction particles toward and/or into the reactor enclosure.
Example 134. The method of any example herein, particularly any one of examples 124-133, wherein the introducing the flow of the reaction gas comprises regulating a flow rate of the reaction gas into the reactor enclosure.
Example 135. The method of any example herein, particularly any one of examples 124-134, wherein the introducing the flow of the reaction gas comprises flowing the reaction gas through a sparger disposed within the reactor enclosure.
Example 136. The method of any example herein, particularly any one of examples 124-135, wherein the introducing the flow of the reaction gas comprises flowing the reaction gas through a perforated plate disposed within the reactor enclosure.
Example 137. The method of any example herein, particularly any one of examples 124-136, wherein the chemical reaction comprises an exothermic chemical reaction, and wherein the method comprises extracting heat energy from the reaction assembly.
Example 138. The method of any example herein, particularly example 137, wherein the extracting the heat energy comprises conveying heat energy from the reactive bed region of the reaction assembly to a process fluid via a heat exchanger.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A reaction assembly for facilitating a chemical reaction between a reaction gas and reaction particles within a reactor system, the reaction assembly comprising:
a reaction assembly housing configured to support a flow of the reaction gas in an upstream direction and a flow of the reaction particles in a downstream direction opposite to the upstream direction;
a moving bed region;
a gas acceleration region upstream of the moving bed region; and
a reactive bed region upstream of the gas acceleration region,
wherein the gas acceleration region comprises:
a nozzle configured to accelerate the reaction gas; and
one or more downcomer regions defined between the nozzle and the reaction assembly housing, and
wherein the reaction assembly is configured such that, during operative use of the reaction assembly:
the reaction gas flows in contact with the reaction particles in the moving bed region;
a portion of the flow of the reaction gas is accelerated within the gas acceleration region to produce a fluidizing gas flow; and
the fluidizing gas flow causes fluidizing of the reaction particles within the spouted bed region to facilitate the chemical reaction between the reaction gas and the reaction particles within the spouted bed region.

2. The reaction assembly of claim 1, wherein the reactive bed region comprises a spouted bed region, and wherein the fluidizing gas flow comprises a spouting gas flow that causes spouting of the reaction particles within the spouted bed region to facilitate the chemical reaction between the reaction gas and the reaction particles within the spouted bed region.

3. The reaction assembly of claim 1, wherein the reaction assembly is configured such that, during operative use of the reaction assembly, the reaction particles flow from the reactive bed region to the moving bed region only via the gas acceleration region.

4. The reaction assembly of claim 1, wherein the reaction assembly is configured such that, during operative use of the reaction assembly:
(i) the reaction gas has a superficial velocity within the moving bed region that is lower than a fluidizing gas velocity corresponding to the reaction particles; and
(ii) the superficial velocity of the fluidizing gas flow is greater than a spouting gas velocity corresponding to the reaction particles.

5. The reaction assembly of claim 1, wherein the reaction assembly is configured such that, during operative use of the reaction assembly:
(i) a temperature of one or both of the reaction particles and the reaction gas within the reactive bed region is at least substantially uniform; and
(ii) a temperature of one or both of the reaction particles and the reaction gas within the moving bed region decreases along the downstream direction.

6. The reaction assembly of claim 1, wherein the nozzle defines a nozzle interior region, and wherein the reaction assembly is configured such that the nozzle interior region is at least partially free of reaction particles during operative use of the reaction assembly.

7. The reaction assembly of claim 1, wherein the nozzle extends between and comprises a nozzle inlet configured to receive the reaction gas and a nozzle outlet configured to expel the reaction gas, wherein the nozzle inlet has a nozzle inlet cross-sectional area, as measured in a plane extending perpendicular to the upstream direction, wherein the nozzle outlet has a nozzle outlet cross-sectional area, as measured in a plane extending perpendicular to the upstream direction, that is less than the nozzle inlet cross-sectional area, and wherein a ratio of the nozzle inlet cross-sectional area to the nozzle outlet cross-sectional area is at least 60:1.

8. The reaction assembly of claim 1, wherein the nozzle extends between and comprises a nozzle inlet configured to receive the reaction gas and a nozzle outlet configured to expel the reaction gas, wherein the nozzle inlet has a nozzle inlet cross-sectional area, as measured in a plane extending perpendicular to the upstream direction, wherein the reaction assembly housing as a housing cross-sectional area, as measured in the plane in which the nozzle inlet cross-sectional area is measured, and wherein a ratio of the nozzle inlet cross-sectional area to the housing cross-sectional area is 0.3:1-0.7:1.

9. The reaction assembly of claim 1, wherein the nozzle extends between and comprises a nozzle inlet configured to receive the reaction gas and a nozzle outlet configured to expel the reaction gas, wherein the nozzle has a nozzle height, as measured between the nozzle inlet and the nozzle outlet along the downstream direction, wherein the nozzle has a nozzle maximum width, as measured along a direction perpendicular to the downstream direction, and wherein a ratio of the nozzle height to the nozzle maximum width at least 0.5:1 and at most 2:1.

10. The reaction assembly of claim 1, wherein the nozzle is a first nozzle, and wherein the gas acceleration region further comprises a second nozzle configured to accelerate the reaction gas.

11. The reaction assembly of claim 1, wherein each downcomer region is defined by one or both of:
(i) a nozzle outer surface of the nozzle; and
(ii) an interior surface of the reaction assembly housing, and
wherein each downcomer region is configured such that, during operative use of the reaction assembly, a downcomer gas flow of the reaction gas flows through the downcomer region in the upstream direction with a downcomer gas flow velocity that is sufficiently small to allow the reaction particles to flow through the downcomer region in the downstream direction.

12. A reactor system comprising:
a reactor enclosure;
a reaction particle inlet configured to introduce reaction particles into the reactor enclosure, wherein the reactor system is configured such that the reaction particles flow through the reactor enclosure in a downstream direction;
a reaction gas inlet configured to introduce a flow of a reaction gas into the reactor enclosure, wherein the reactor system is configured such that the reaction gas flows through the reactor enclosure in an upstream direction opposite to the downstream direction; and
a reaction assembly disposed between the reaction particle inlet and the reaction gas inlet, wherein the reaction assembly comprises:
a reaction assembly housing configured to support a flow of the reaction gas in an upstream direction and a flow of the reaction particles in a downstream direction opposite to the upstream direction;
a moving bed region;
a gas acceleration region upstream of the moving bed region; and
a reactive bed region upstream of the gas acceleration region,
wherein the gas acceleration region comprises:
a nozzle configured to accelerate the reaction gas; and
one or more downcomer regions defined between the nozzle and the reaction assembly housing, and
wherein the reaction assembly is configured such that, during operative use of the reaction assembly:
the reaction gas flows in contact with the reaction particles in the moving bed region;
a portion of the flow of the reaction gas is accelerated within the gas acceleration region to produce a fluidizing gas flow; and
the fluidizing gas flow causes fluidizing of the reaction particles within the spouted bed region to facilitate the chemical reaction between the reaction gas and the reaction particles within the spouted bed region.

13. The reactor system of claim 12, further comprising a heat exchanger configured to bring a process fluid into thermal contact with the reaction assembly, wherein the heat exchanger is configured to convey heat energy from the reaction assembly housing to the process fluid.

14. The reactor system of claim 12, further comprising a particle feed subassembly configured to introduce the reaction particles to the reactor enclosure via the reaction particle inlet, and wherein the particle feed subassembly comprises an active feed mechanism configured to regulate a feed rate at which the reaction particles are introduced into the reactor enclosure.

15. The reactor system of claim 12, further comprising a particle disposal subassembly disposed downstream of the moving bed region and configured to remove the reaction particles from the reactor enclosure.

16. The reactor system of claim 15, wherein the particle disposal subassembly comprises:
a waste particle conduit configured to convey the reaction particles away from the reactor enclosure; and
wherein the particle disposal subassembly comprises a waste particle receptacle configured to receive and store the reaction particles removed from the reactor enclosure, and
wherein the particle disposal subassembly is configured to restrict the reaction gas from exiting the reactor enclosure via the particle disposal subassembly.

17. A method of operating a reactor system, the method comprising:
introducing a flow of reaction particles into a reactor enclosure of the reactor system;
flowing the reaction particles through the reactor enclosure in a downstream direction;
introducing a flow of a reaction gas into the reactor enclosure such the reaction gas flows through the reactor enclosure in an upstream direction opposite to the downstream direction; and
flowing the reaction gas in contact with the reaction particles within a reaction assembly of the reactor system such that the reaction gas interacts with the reaction particles to produce:
a moving bed region of the reaction assembly, in which the reaction gas flows in contact with the reaction particles and flows with a superficial velocity that is lower than a fluidizing gas velocity corresponding to the reaction particles;
a gas acceleration region of the reaction assembly, in which a first portion of the flow of reaction gas is accelerated to produce a fluidizing gas flow with a superficial velocity that is greater than a fluidizing gas velocity corresponding to the reaction particles and in which the reaction particles flow in the downstream direction in contact with a second portion of the flow of reaction gas; and
a reactive bed region of the reaction assembly, in which the fluidizing gas flow causes fluidizing of the reaction particles to facilitate a chemical reaction between the reaction gas and the reaction particles.

18. The method of claim 17, wherein the fluidizing gas flow comprises a spouting gas flow with a superficial velocity that is greater than a spouting gas velocity corresponding to the reaction particles, and wherein the reactive bed region comprises a spouted bed region in which the spouting gas flow causes spouting of the reaction particles to facilitate the chemical reaction between the reaction gas and the reaction particles.

19. The method of claim 17, wherein the flowing the reaction particles through the reactor enclosure comprises flowing such that the reaction particles flow from the reactive bed region to the moving bed region only via the gas acceleration region.

20. The method of claim 17, wherein the introducing the flow of reaction particles comprises regulating a flow rate of the reaction particles into the reactor enclosure via an active feed mechanism.

21. The method of claim 17, wherein the introducing the flow of the reaction gas comprises regulating a flow rate of the reaction gas into the reactor enclosure.

22. The method of claim 17, wherein the chemical reaction comprises an exothermic chemical reaction, and wherein the method comprises extracting heat energy from the reaction assembly by conveying heat energy from the spouted bed region of the reaction assembly to a process fluid via a heat exchanger.
